(19) United States
(12) Patent Application Publication
(10) Pub. No.: US 2016/0202867 A1
(43) Pub. Date: Jul. 14, 2016

(54) ELECTRONIC APPARATUS, RECORDING MEDIUM AND OPERATING METHOD OF ELECTRONIC APPARATUS

(71) Applicant: KYOCERA CORPORATION, Kyoto (JP)

(72) Inventors: Tomoki IWAIZUMI, Osaka (JP); Keisuke NAGATA, Hyogo (JP)

(73) Assignee: KYOCERA CORPORATION

(21) Appl. No.: 15/077,721

(22) Filed: Mar. 22, 2016

Related U.S. Application Data
(63) Continuation of application No. PCT/JP2014/075523, filed on Sep. 25, 2014.

(30) Foreign Application Priority Data
Sep. 26, 2013 (JP) 2013-200305

(51) Int. Cl. G06F 3/0485; H04M 1/57

(52) U.S. Cl. CPC G06F 3/0485; H04M 1/576

(57) ABSTRACT

The display controller has an operation mode for enabling a display to display a plurality of application-relevant images, by scrolling a first display screen displayed by the display and including an application-relevant image. The display controller scrolls the first display screen when an operation detector detects a scrolling operation of the first display screen. The display controller in the operation mode has a display mode in which the first display screen is displayed on the display so that a specific application-relevant image is more prominent among the application-relevant images. The display controller in the display mode determines whether or not to maintain the display mode, based on the scrolling operation detected by the operation detector.

### CROSS-REFERENCE TO RELATED APPLICATIONS

The present application is a continuation of PCT Application No. PCT/JP2014/75523, filed on Sep. 25, 2014, which claims the benefit of Japanese Patent Application No. 2013-200305, filed on Sep. 26, 2013. PCT Application No. PCT/JP2014/75523 is entitled “ELECTRONIC DEVICE, CONTROL PROGRAM, AND METHOD FOR OPERATING ELECTRONIC DEVICE”, and Japanese Patent Application No. 2013-200305 is entitled “ELECTRONIC APPARATUS, CONTROL PROGRAM, AND OPERATING METHOD OF ELECTRONIC APPARATUS”. The contents of which are incorporated by reference herein in their entirety.

### FIELD

Embodiments of the present disclosure relate to electronic apparatuses.

### BACKGROUND

Various techniques concerning electronic apparatuses have been proposed.

### SUMMARY

An electronic apparatus, a recording medium, and an operating method of an electronic apparatus are disclosed. In one embodiment, an electronic apparatus includes a storage, a display, a display controller, and an operation detector. The storage stores an application program. The display controller causes the display to display an application-relevant image corresponding to the application program. The operation detector detects an operation of an operator on the display. The display controller has an operation mode for enabling the display to display a plurality of application-relevant images by scrolling a display screen displayed by the display, the display screen including the application-relevant image. The display controller in the operation mode causes the display screen to be scrolled when the operation detector detects a scrolling operation of the display screen. The display controller in the operation mode has a display mode in which the display screen is displayed on the display so that a specific application-relevant image is more prominent among the application-relevant images. The display controller in the display mode determines whether or not to maintain the display mode, based on the scrolling operation detected by the operation detector.

In one embodiment, a non-transitory computer-readable recording medium stores a program for controlling an electronic apparatus. The electronic apparatus includes a display and a storage that stores an application program. The program causes the electronic apparatus to execute the steps (a) to (e). The step (a) is a step of operating the electronic apparatus in an operation mode for enabling the display to display a plurality of application-relevant images by scrolling a display screen including an application-relevant image corresponding to the application program, the display screen being displayed by the display. The step (b) is a step of operating the electronic apparatus in a display mode in which the display screen is displayed on the display so that a specific application-relevant image is more prominent among the application-relevant images, when the electronic apparatus is in the operation mode. The step (c) is a step of detecting a scrolling operation of the display screen on the display by an operator. The step (d) is a step of scrolling the display screen, when the electronic apparatus is in the operation mode and the scrolling operation is detected in the step (c). The step (e) is a step of shifting to the display mode, when the electronic apparatus is in the operation mode and the scrolling operation is detected in the step (c). The step (f) is a step of determining whether or not to maintain the display mode based on the scrolling operation detected in the step (c), when the electronic apparatus is in the display mode.

In one embodiment, an operating method of an electronic apparatus including a display and a storage that stores an application program includes the steps (a) to (e). The step (a) is a step of operating in an operation mode for enabling the display to display a plurality of application-relevant images by scrolling a display screen including an application-relevant image corresponding to the application program, the display screen being displayed by the display. The step (b) is a step of operating in a display mode in which the display screen is displayed on the display so that a specific application-relevant image is more prominent among the application-relevant images, when the electronic apparatus is in the operation mode. The step (c) is a step of detecting a scrolling operation of the display screen on the display by an operator. The step (d) is a step of scrolling the display screen, when the electronic apparatus is in the operation mode and the scrolling operation is detected in the step (c). The step (e) is a step of determining whether or not to maintain the display mode based on the scrolling operation detected in the step (c), when the electronic apparatus is in the display mode. The step (f) is a step of shifting to the display mode, when the electronic apparatus detects start of an operation while detecting no operation on the display.

### BRIEF DESCRIPTION OF DRAWINGS

FIG. 1 illustrates a front view showing the appearance of an electronic apparatus.

FIG. 2 illustrates a back view showing the appearance of the electronic apparatus.

FIG. 3 illustrates a block diagram showing an electrical configuration of the electronic apparatus.

FIG. 4 illustrates a display example of the electronic apparatus.

FIG. 5 illustrates images displayed by the electronic apparatus.

FIG. 6 illustrates images displayed by the electronic apparatus.

FIG. 7 illustrates a display example of the electronic apparatus.

FIG. 8 illustrates a display example of the electronic apparatus.

FIG. 9 illustrates a functional configuration of the electronic apparatus.

FIG. 10 illustrates an outline of processing performed by the electronic apparatus.

FIG. 11 illustrates a display example of the electronic apparatus.

FIG. 12 illustrates a flowchart of processes performed by the electronic apparatus.

FIG. 13 illustrates processes performed by the electronic apparatus.

FIG. 14 illustrates a flowchart of processes performed by the electronic apparatus.

FIG. 15 illustrates processes performed by the electronic apparatus.

FIG. 16 illustrates a flowchart of processes performed by the electronic apparatus.

FIG. 17 illustrates processes performed by the electronic apparatus.

FIG. 18 illustrates a flowchart of processes performed by the electronic apparatus.

FIG. 19 illustrates processes performed by the electronic apparatus.

FIG. 20 illustrates processes performed by the electronic apparatus.

FIG. 21 illustrates processes performed by the electronic apparatus.

FIG. 22 illustrates a flowchart of processes performed by the electronic apparatus.

FIG. 23 illustrates processes performed by the electronic apparatus.

FIG. 24 illustrates processes performed by the electronic apparatus.

FIG. 25 illustrates a flowchart of processes performed by the electronic apparatus.

FIG. 26 illustrates processes performed by the electronic apparatus.

FIG. 27 illustrates processes performed by the electronic apparatus.

FIG. 28 illustrates a display example of the electronic apparatus.

FIG. 29 illustrates a display example of the electronic apparatus.

FIG. 30 illustrates a display example of the electronic apparatus.

FIG. 31 illustrates a display example of the electronic apparatus.

FIG. 32 illustrates a display example of the electronic apparatus.

FIG. 33 illustrates a display example of the electronic apparatus.

FIG. 34 illustrates a display example of the electronic apparatus.

FIG. 35 illustrates a display example of the electronic apparatus.

FIG. 36 illustrates a display example of the electronic apparatus.

FIG. 37 illustrates a display example of the electronic apparatus.

FIG. 38 illustrates a display example of the electronic apparatus.

FIG. 39 illustrates a display example of the electronic apparatus.

FIG. 40 illustrates a display example of the electronic apparatus.

FIG. 41 illustrates a display example of the electronic apparatus.

FIG. 42 illustrates a display example of the electronic apparatus.

FIG. 43 illustrates a display example of the electronic apparatus.

FIG. 44 illustrates a display example of the electronic apparatus.

FIG. 45 illustrates a display example of the electronic apparatus.

FIG. 46 illustrates images displayed by the electronic apparatus.

FIG. 47 illustrates a display example of the electronic apparatus.

FIG. 48 illustrates images displayed by the electronic apparatus.

FIG. 49 illustrates a display example of the electronic apparatus.

FIG. 50 illustrates images displayed by the electronic apparatus.

FIG. 51 illustrates a display example of the electronic apparatus.

### DETAILED DESCRIPTION

[[Appearance of Electronic Apparatus]]

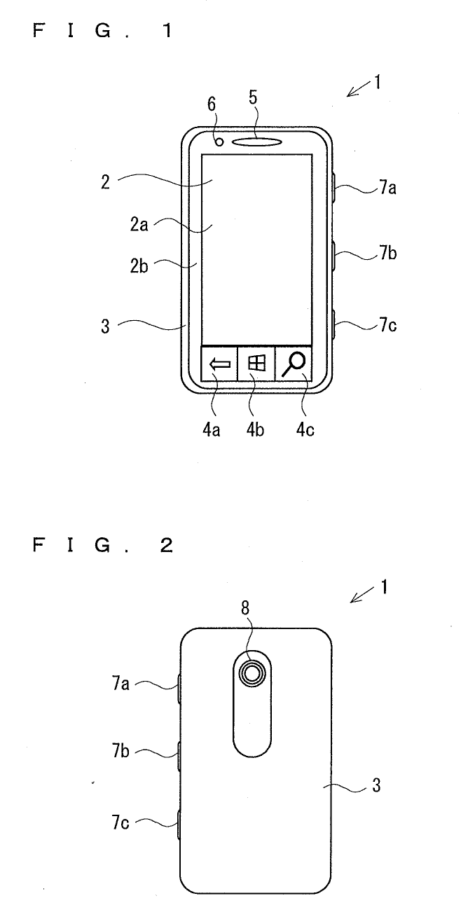

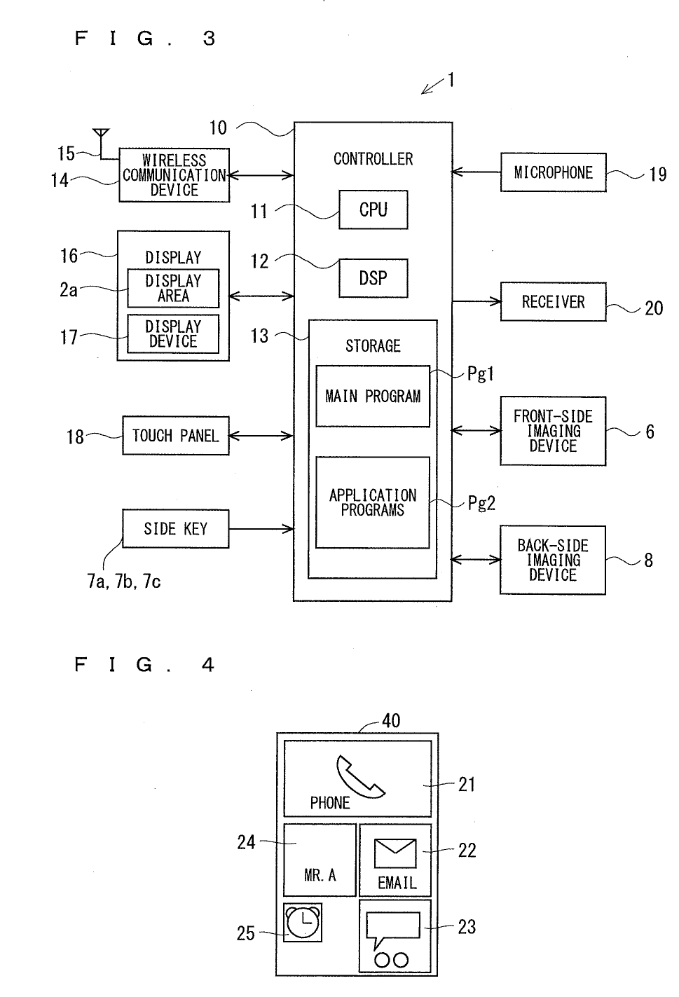

FIGS. 1 and 2 respectively illustrate a front view and a back view showing the appearance of an electronic apparatus 1 according to one embodiment. The electronic apparatus 1 according to one embodiment is a mobile phone, for example. The electronic apparatus 1 can communicate with another communication apparatus through a base station, a server, and the like. As illustrated in FIGS. 1 and 2, the electronic apparatus 1 has an approximately rectangular plate-like shape in a plan view. The electronic apparatus 1 includes a cover panel 2 and a case part 3.

As illustrated in FIG. 1, the cover panel 2 has a display region 2a, a peripheral region 2b, and operation keys 4a, 4b, and 4c. The cover panel 2 is made, for example, of transparent glass or a transparent acrylic resin. A display device 17 and a touch panel 18 to be described below are provided on a back side of the cover panel 2.

A variety of information, including characters, signs, graphic symbols, and images, displayed by the display device 17 is viewed by a user through the display area 2a of the cover panel 2. The peripheral region 2b, which surrounds the display region 2a, of the cover panel 2 is black, for example, because a film or the like has been applied thereto. Display of the display device 17 is not viewed by the user in the peripheral region 2b. The display region 2a of the cover panel 2 and the display device 17 are collectively referred to as a display 16. Information displayed by the display 16 is viewed from the outside of the electronic apparatus 1.

The touch panel 18 can receive operations performed on the display region 2a and the operation keys 4a, 4b, and 4c with an operator, such as a finger. The operation keys 4a, 4b, and 4c are software keys in one embodiment. The operation key 4a is an operation key to return display of the display 16 to a preceding state, for example. The operation key 4b is an operation key to cause the display 16 to display a start screen (an initial screen), for example. The operation key 4c is an operation key to cause the display 16 to display a search screen, for example. A graphic symbol, characters, or the like representing the operation key 4a is/are printed on the operation key 4a. Similarly, a graphic symbol, characters, or the like representing the operation key 4b is/are printed on the operation key 4b. A graphic symbol, characters, or the like representing the operation key 4c is/are also printed on the operation key 4c. The graphic symbols, characters, or the like representing the operation keys 4a, 4b, and 4c may not be printed, and may be displayed by the display device 17. The operation keys 4a, 4b, and 4c may not be the software keys, and may be hardware keys.

The cover panel 2 has a receiver hole 5 and a front-side imaging device 6 in an upper end portion thereof. As illustrated in FIG. 2, the electronic apparatus 1 has a back-side imaging device 8 on a back side thereof. Side keys 7a, 7b, and 7c are provided on a side of the electronic apparatus 1. The side key 7a is an operation key to adjust the volume of sound output from a receiver. The side key 7b is an operation key to activate the electronic apparatus 1. This means that the side key 7b is an operation key to power on or off the electronic apparatus 1. The side key 7c is an operation key to cause the back-side imaging device 8 to capture an image.

[Electrical Configuration of Electronic Apparatus]

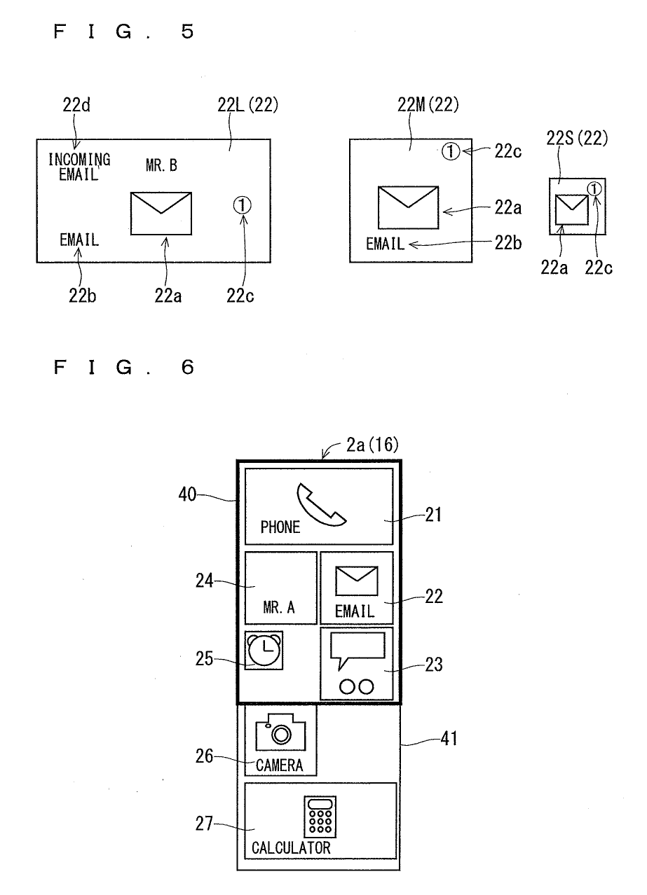

FIG. 3 illustrates a block diagram showing an electrical configuration of the electronic apparatus 1. As illustrated in FIG. 3, the electronic apparatus 1 includes a controller 10, a wireless communication device 14, the display 16, the touch panel 18, the side keys 7a, 7b, and 7c, a microphone 19, a receiver 20, the front-side imaging device 6, and the back-side imaging device 8.

The controller 10 includes a central processing unit (CPU) 11, a digital signal processor (DSP) 12, and a storage 103. The controller 10 can control other components of the electronic apparatus 1 to perform overall control of operations of the electronic apparatus 1.

The storage 13 includes a non-transitory recording medium that can be read by the controller 10 (a CPU 11 and a DSP 12), such as a read only memory (ROM) and a random access memory (RAM). The storage 13 may include a non-transitory computer-readable recording medium other than the ROM and the RAM. The storage 13 can store a main program Pg1 and a plurality of application programs Pg2. The main program Pg1 is a control program for controlling operations of the electronic apparatus 1, specifically, the components of the electronic apparatus 1 such as the wireless communication device 14 and the display 16. Various functions of the controller 10 can be performed by causing the CPU 11 and the DPS 12 to execute various programs in the storage 13. The application programs will be simply referred to as “applications” hereinafter.

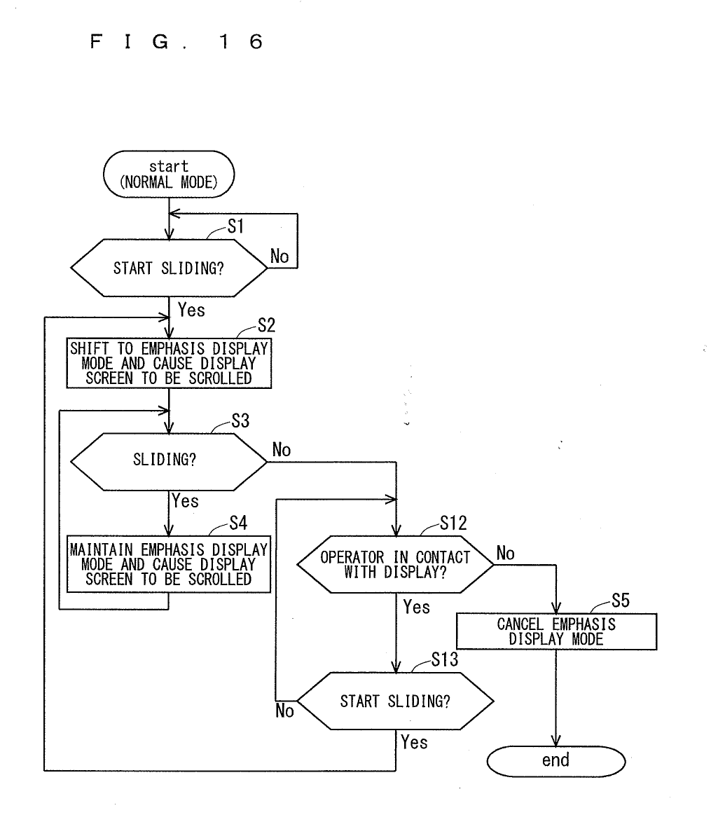

Although the electronic apparatus 1 includes the single CPU 11 and the single DSP 12 in one embodiment, the electronic apparatus 1 may include a plurality of CPUs 11 and a plurality of DSPs 12. This means that the electronic apparatus 1 may include at least the CPU 11 and at least the DSP 12. The CPU 11 and the DPS 12 may cooperate with each other to achieve various functions related to the electronic apparatus 1. The controller 10 may not include the storage 13 unlike in FIG. 13. This means that the storage 13 may be provided separately from the controller 10.

The storage 13 can store, as the applications Pg2, a phone application for performing communication with another mobile phone and an email application for sending and receiving emails, for example. The applications Pg2 are read and executed during running of the main program Pg1 to achieve functions, such as functions to perform communication and to send an email, in the electronic apparatus 1. In FIG. 3, only a single application Pg2 is shown to avoid complications.

The wireless communication device 14 has an antenna 15. The wireless communication device 14 can transmit and receive, through, for example, the base station via the antenna 15, a communication signal to and from a mobile phone other than the electronic apparatus 1 or a communication apparatus connected to the Internet such as a web server.

The display 16 includes the display region 2a and the display device 17. The display device 17 is a liquid crystal display or an organic EL display, for example. As described above, in the display 16, the variety of information displayed by the display device 17 is viewed from the outside of the electronic apparatus 1 through the display region 2a.

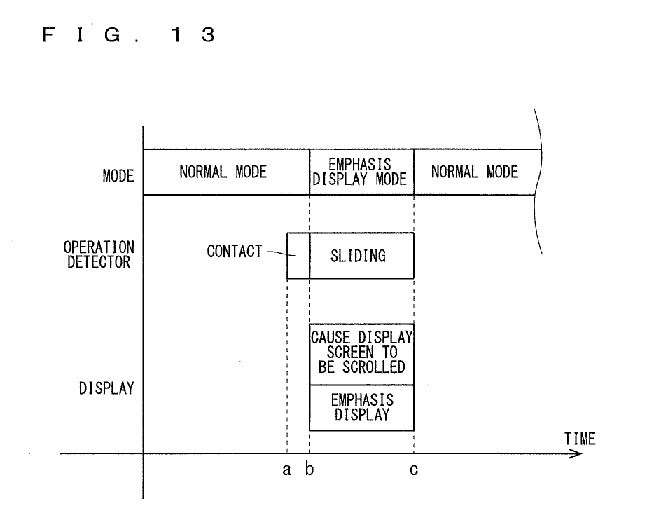

The touch panel 18 is a projected capacitive touch panel, for example. The touch panel 18 is stuck on the back side of the cover panel 2. The touch panel 18 includes two sheet electrode sensors facing each other. When the user contacts the display region 2a of the display 16 with the operator, such as a finger, the capacitance in a portion of the touch panel 18 facing the operator changes. The touch panel 18 can output, to the controller 10, an electrical signal corresponding to the change in capacitance. As described above, the touch panel 18 can detect the contact of the operator with the display 16 (display region 2a). The touch panel 18 can also detect operations performed on the operation keys 4a, 4b, and 4c, and transmit electrical signals to the controller 10. The touch panel 18 functions as an operation detector 50 (see FIG. 9 to be described later) that detects an operation of the operator on the display region 2a of the display 16. The user can provide various instructions to the electronic apparatus 1 also by operating the display 16 with an operator other than the finger, such as, pens for electrostatic touch panels including a stylus pen.

The detection sensitivity of the touch panel 18 is set high in one embodiment. Thus, the capacitance in the portion of the touch panel 18 facing the operator changes even if the operator is not in contact with but in close proximity to the display region 2a. Thus, the touch panel 18 can also detect the close proximity of the operator to the display 16 (display region 2a). This means that the touch panel 18 can detect the contact and the close proximity of the operator with and to the display 16 (display region 2a). In one embodiment, the state of the operator being in contact with the display 16 (display region 2a) includes the state of the operator being in close proximity to the display 16. This means that detection by the touch panel 18 of the contact of the operator with the display 16 includes detection by the touch panel 18 of the close proximity of the operator to the display 16.

The side keys 7a, 7b, and 7c can transmit electrical instruction signals to the controller 10 upon being pressed. The microphone 18 can receive, for example, voice of the user during communication, convert the voice as input into electrical signals, and output the electrical signals to the controller 10. The receiver 20 can convert electrical sound signals input from the controller 10 during, for example, communication into sound, and output the sound to provide received sound to the user. The front-side imaging device 6 and the back-side imaging device 8 can capture still images and moving images.

[[Kinds of Operations on Display Region]]

The basic operations of the user on the display 16 include, for example, tapping, sliding, and flicking.

The tapping is an operation in which the operator moves away from the display 16 upon contact with the display 16. Specifically, the tapping is an operation in which the operator moves away from a contact point or a point in proximity to the contact point in the display region 2a, within a predetermined time after the operator is in contact with the display region 2a of the display 16. The tapping on the display 16 allows, for example, the user to select an image for executing the applications Pg2 displayed on the display 16, thus enabling the electronic apparatus 1 to execute the applications Pg2.

The sliding is an operation in which the operator moves while being in contact with the display region 2a of the display 16. Specifically, the sliding is an operation in which the operator moves in the display region 2a. The sliding on the display 16 by the user enables, for example, the electronic apparatus 1 to scroll the display of the display 16 and switch the page displayed on the display 16 to another page.

The flicking is an operation in which the operator swipes the display region 2a of the display 16. Specifically, the flicking is an operation in which the operator moves by a predetermined distance or more within a predetermined time while being in contact with the display region 2a, and leaves the display region 2a. The flicking on the display 16 by the user enables, for example, the electronic apparatus 1 to scroll the display of the display 16 in a direction where the operator moves in the flicking, and switch the page displayed on the display 16 to another page.

The sliding and the flicking may be called a scrolling operation in one embodiment.

[[Initial Screen Mode]]

An initial screen (start screen) mode executed by the electronic apparatus 1 upon startup of the electronic apparatus 1 or when the operation key 4b is operated will be described hereinafter. In executing the initial screen mode, an image associated with an application (hereinafter may be referred to as “application-relevant image”) is displayed on the display 16. When this application-relevant image is tapped, the application corresponding to the application-relevant image is executed in the electronic apparatus 1. Thus, the application-relevant image is an image for executing the corresponding application. The application-relevant image may be referred to as “tile” or “icon”. An image hereinafter means the application-relevant image unless otherwise specified. The images include graphic symbols indicating applications corresponding to the images, which will be described later in detail. The user can understand the application corresponding to an image, based on, for example, the graphic symbol included in the image.

FIG. 4 illustrates an example of a display screen 40 displayed on the display 16 in the initial screen mode. Although the display screen 40 is displayed in the entire display region 2a of the display 16 herein, a screen that does not include any application-relevant image may be displayed together with the display screen 40 on the display 16.

The display screen 40 includes images 21, 22, 23, 24, and 25. The image 21 is an image corresponding to a phone application. For example, when the user taps the image 21, the phone application is executed in the electronic apparatus 1. The image 22 is an image corresponding to an email application. The image 23 is an image corresponding to an instant message application for exchanging short messages with another communication apparatus in real time. The image 24 is an image corresponding to a phone directory application providing a specific name (for example, Mr. A in FIG. 4) registered in the phone directory and information associated with the specific name in the phone directory. For example, when the user taps the image 24, the specific name (Mr. A) registered in the phone directory and the information associated with the specific name are displayed on the display 16. In other words, the phone directory application is an application for displaying, on the display 16, the specific name registered in the phone directory and the information associated with the specific name. The image 25 is an image corresponding to an alarm application for notifying the user of a set time.

[Images Displayed in Initial Screen Mode]

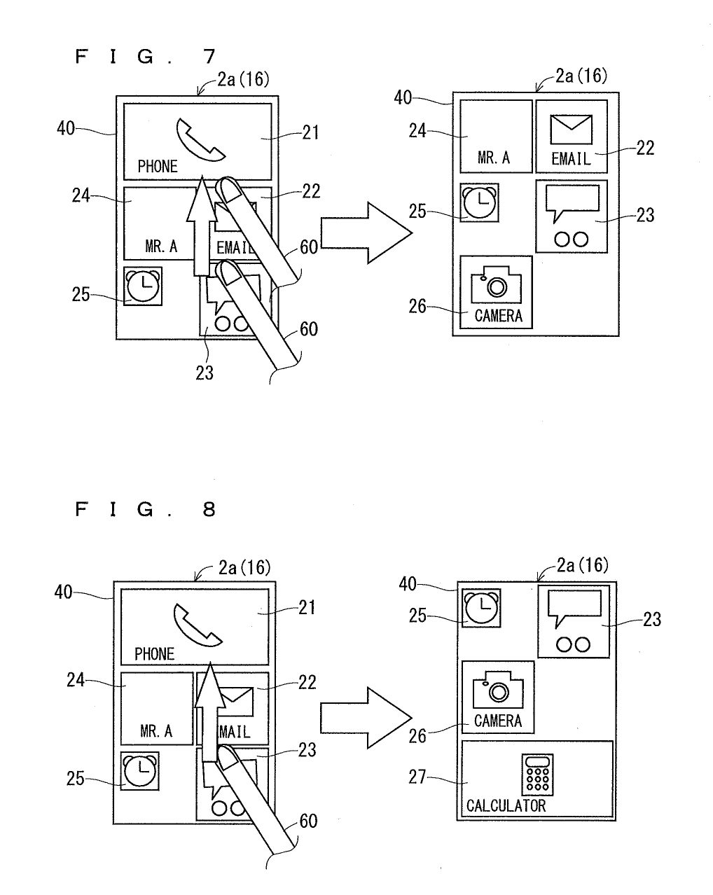

As illustrated in FIG. 4, the sizes of the images displayed in the initial screen mode are not uniform. Differences in information included in the images due to the different sizes of the images will be described with reference to FIG. 5. One embodiment when the sizes of the images are, for example, three will be described hereinafter. The user can freely change the size and the position of each image when the operation mode of the electronic apparatus 1 is set to a mode for changing the size and the position of the image.

FIG. 5 illustrates the image 22 corresponding to the email application. FIG. 5 illustrates three images that differ in size and correspond to the email application, namely, images 22L, 22M, and 22S in descending order of size.

The image 22L is the largest among the three images 22S, 22M, and 22L. The image 22L is a horizontally oriented rectangle having an aspect ratio of, for example, 1:2 as illustrated in FIG. 5. The image 22L includes a graphic symbol 22a indicating an email application, and text information 22b.

A graphic symbol included in an image is selected to represent an application corresponding to the image. For example, as illustrated in FIG. 5, the graphic symbol 22a represented by an envelope symbolizing an email application is selected in the image 22. Furthermore, the text information included in the images is a name of an application corresponding to the images. The text information 22b in FIG. 5 is “EMAIL”. The user can recognize the application corresponding to an image, based on a graphic symbol or text information included in the image.

Furthermore, an image sometimes includes text information obtained by a part of the functions to be achieved by executing an email application (hereinafter referred to as “partial application function”) corresponding to the image, other than the graphic symbol and the text information each indicating the application corresponding to the image. Examples of the partial application function include an email receiving function among the functions to be achieved by executing an email application. Furthermore, information obtained by the partial application function is information related to, for example, incoming emails in executing the email application. The image 22L includes the number of incoming emails 22c and a sender name 22d of the latest incoming email.

The image 22M is medium in size among the three images 22S, 22M, and 22L. As illustrated in FIG. 5, the image 22M is, for example, a square with sides half a horizontal side of the image 22L. Furthermore, the image 22M includes the graphic symbol 22a, the text information 22b, and the number of incoming emails 22c.

The image 22S is the smallest among the three images 22S, 22M, and 22L. As illustrated in FIG. 5, the image 22S is, for example, a square with sides half the vertical and horizontal sides of the image 22M. The image 22S includes the graphic symbol 22a and the number of incoming emails 22c.

[Scrolling of Display Screen]

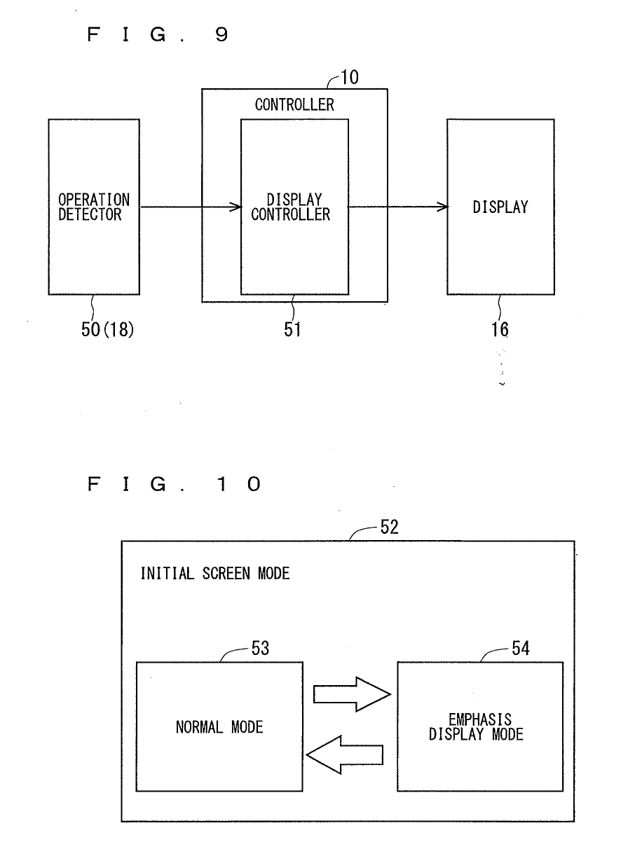

In the initial screen mode, one display target image 41 including at least one image is generated. At least a part of the display target image 41 corresponds to a display screen 40 to be displayed on the display 16. When many images are arranged in the display target image 41, the display target image 41 becomes larger. Thus, the electronic apparatus 1 sometimes cannot display the display target image 41 on the display 16 at one time. Here, the display screen 40 to be displayed on the display 16 includes a part of the display target image 41 as illustrated in FIG. 6. In other words, the display screen 40 sometimes does not include a part of images included in the display target image 41.

In FIG. 6, the images 21, 22, 23, 24, and 25 included in the display target image 41 are displayed on the display 16 and included in the display screen 40. In contrast, images 26 and 27 included in the display target image 41 are neither displayed on the display 16 nor included in the display screen 40. The image 26 is an image corresponding to a camera application for capturing images by the front-side imaging device 6 and the back-side imaging device 8. The image 27 is an image corresponding to a calculator application for executing a calculator function.

When the display target image 41 is not displayed on the display 16 at one time, the user can change, by performing a scrolling operation on (sliding or flicking) the display 16, partial images to be displayed on the display 16, that is, partial images included in the display screen 40, in the display target image 41. In other words, the user can scroll the display screen 40 within the display target image 41 by performing a scrolling operation on the display 16. Specifically, the user can display, on the display 16, a partial image that the user desires to be included in the display screen 40 in the display target image 41 by performing a scrolling operation in a direction opposite to the desired partial image with respect to partial images currently being displayed on the display 16, that is, the partial images currently included in the display screen 40. For example, when a partial image disposed lower than the partial image currently displayed on the display 16 is desired to be displayed on the display 16, in the display target image 41, the partial image disposed lower is displayed on the display 16 by the user performing a scrolling operation on the display 16 upward to slide down the display range in the display target image 41.

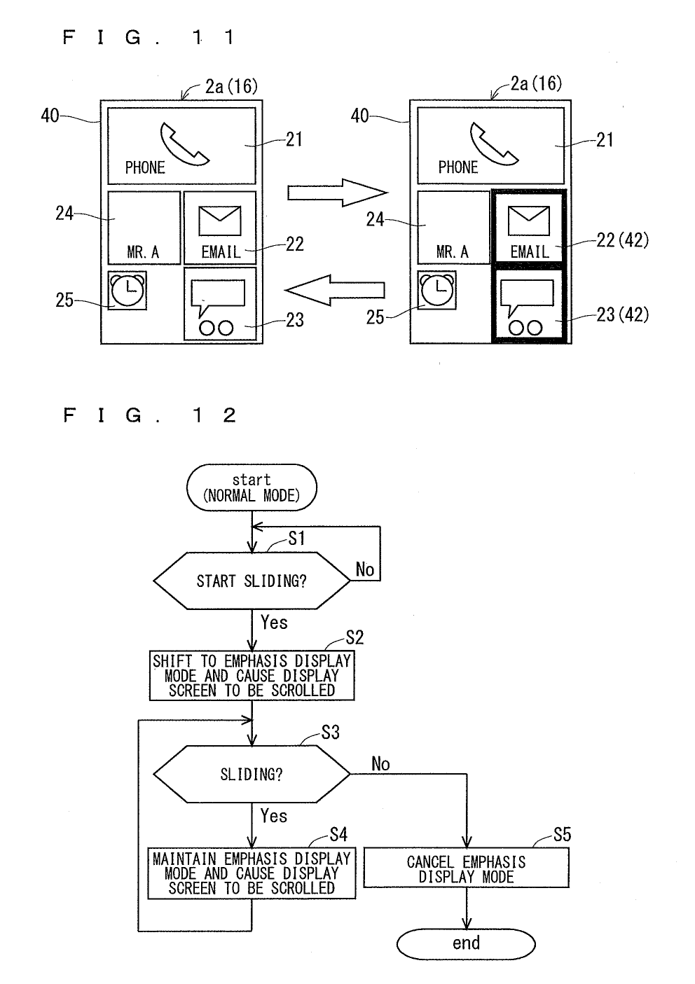

FIG. 7 illustrates a display example of the display 16 when the display screen 40 is scrolled by sliding. The display 16 (display screen 40) before the sliding is illustrated to the left of FIG. 7, and the display 16 after the sliding is illustrated to the right thereof. As illustrated to the left of FIG. 7, the images 21, 22, 23, 24, and 25 are displayed on the display 16 before the sliding. When an operator 60 slides the display 16 up as illustrated in FIG. 7, the display range of the display target image 41 (FIG. 6) can be moved downward by a distance of the sliding by the operator 60. The display range of the display target image 41 is moved in synchronization with the sliding of the operator 60. When the operator 60 stops sliding, the movement of the display range of the display target image 41 stops, and the scrolling of the display screen 40 displayed on the display 16 also stops. In the example of FIG. 7, the image 26 that is not displayed before the sliding as well as the images 22, 23, 24, and 25 are displayed on the display 16 after the operator 60 slides. The image 21 is not displayed according to the movement of the display range of the display target image 41, and thus is not included in the display screen 40.

FIG. 8 illustrates a display example of the display 16 when the display screen 40 is scrolled by flicking. The display 16 before the flicking is illustrated to the left of FIG. 8, and the display 16 after scrolling by the flicking is illustrated to the right thereof. The images 21, 22, 23, 24, and 25 are displayed on the display 16 before the operator 60 flicks, similarly as FIG. 7. When the operator 60 flicks the display 16 up, the display range of the display target image 41 can be moved downward by an amount (distance) corresponding to the speed at which the operator 60 flicks. The moving distance of the display range of the display target image 41 is determined according to the speed at which the operator 60 flicks in the scrolling. Thus, the scrolling of the display screen 40 does not end until the display range of the display target image 41 finishes moving for a moving distance determined according to the flicking, even after the operator 60 finishes flicking, that is, after the operator 60 is away from the display 16. In the example of FIG. 8, the images 26 and 27 that are not displayed before the flicking are displayed on the display 16, together with the images 23 and 25, after the operator 60 finishes scrolling by the flicking. The images 21, 22, and 24 are not displayed according to the movement of the display range in the display target image 41, and thus are not included in the display screen 40.

When the number of images included in the display target image 41 is many in the initial screen mode, the user has to search the images included in the display target image 41 for a target image, and accordingly, the workload of the user increases. One of the measures against this problem is narrowing down a range from which the target image is searched for, by changing the layout of the images included in the display target image 41 based on usage scenes. However, the user decides the layout of the images included in the display target image 41, in consideration of the usability of the user. It seems not always beneficial to change the layout of the images included in the display target image 41, based on usage scenes. Thus, in the functional blocks and processing to be described below, a specific image (emphaseized image 42) is prominently displayed on the display 16 while the display screen 40 is being scrolled.

[[Functional Blocks in Controller]]

In the controller 10, the main program Pg1 is executed to form the functional blocks. FIG. 9 illustrates a part of the functional blocks formed in the controller 10. As illustrated in FIG. 9, the controller 10 includes a display controller 51.

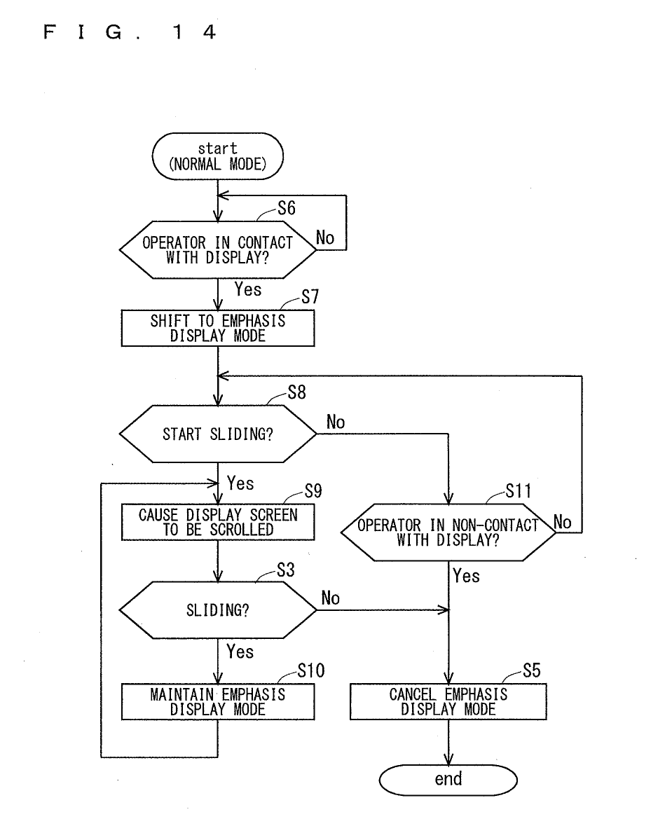

The display controller 51 can cause the display 16 to display an image and/or information, based on an operation of the operator 60 on the display 16 that is detected by the operation detector 50 (touch panel 18). FIG. 10 illustrates an outline of the processing in the initial screen mode.

As illustrated in FIG. 10, the display controller 51 can control switching between a normal mode 53 and an emphasis display mode 54, based on the operation detected by the operation detector 50 in the initial screen mode 52. Upon start of the initial screen mode 52, the display controller 51 is first set to the normal mode 53. The scrolling of the display screen 40 by performing the scrolling operation (sliding or flicking) is one of the controls performed by the display controller 51 in the initial screen mode 52.

FIG. 11 illustrates a display example of the display 16 in the normal mode 53 and the emphasis display mode 54. The example of display in the normal mode 53 is illustrated to the left of FIG. 11, and the example of display in the emphasis display mode 54 is illustrated to the right thereof. As illustrated in FIG. 11, the emphaseized images 42 (the images 22 and 23 in FIG. 11) are prominently displayed in the emphasis display mode 54. Thus, the user can easily search for a target image by checking the emphaseized images prominently displayed in the emphasis display mode 54. In contrast, there is no emphaseized image in the normal mode 53 that is different from the emphasis display mode 54. In other words, each image included in the display target image 41 is normally displayed. The process of selecting an image to be the emphaseized image 42 in the emphasis display mode 54 will be described later in detail.

[[Switching Between Modes by Display Controller]]

[Switching Between Modes: Embodiment 1]

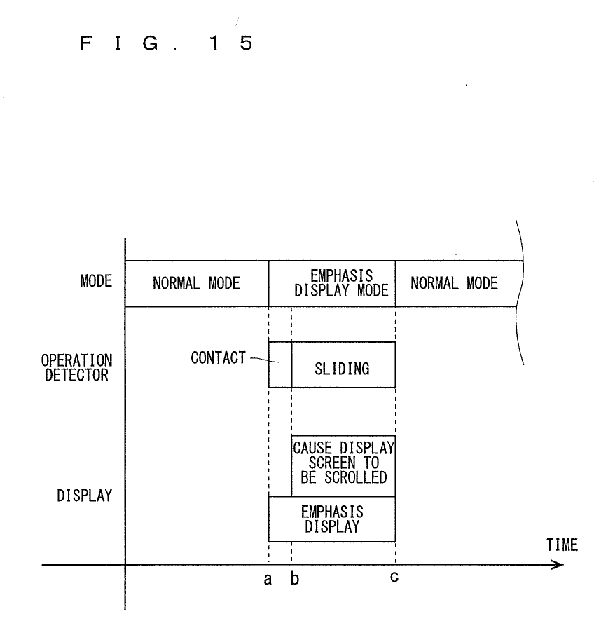

Switching between the normal mode 53 and the emphasis display mode 54 by the display controller 51 will be described with reference to FIG. 12 hereinafter. FIG. 12 illustrates a flowchart of processes performed by the display controller 51 in the switching between modes according to Embodiment 1. Specifically, FIG. 12 illustrates the processes when the display 16 is slided.

Upon the initial screen mode, the display controller 51 controls display on the display 16 in the normal mode 53 (start). Then, the display controller 51 checks whether or not the operator 60 has started sliding, based on a result of the detection by the operation detector 50 (Step S1). When the operation detector 50 does not detect start of the sliding (No at Step S1), the process at Step S1 will be repeated until the operation detector 50 detects the start.

Conversely, when the operation detector 50 detects start of the sliding (Yes at Step S1), the display controller 51 shifts from the normal mode 53 to the emphasis display mode 54, and causes the display screen 40 to be scrolled, based on the sliding detected by the operation detector 50 (Step S2).

Next, the display controller 51 checks whether or not the operation detector 50 continues to detect the sliding (Step S3). When the operation detector 50 continues to detect the sliding (Yes at Step S3), the display controller 51 maintains the emphasis display mode 54, causes the display screen 40 to be scrolled, based on the sliding detected by the operation detector 50 (Step S4), and returns to Step S3._{<0}} Conversely, when the operation detector 50 does not continue to detect the sliding, that is, when the operation detector 50 detects the end of the sliding (No at Step S3), the display controller 51 cancels the emphasis display mode 54, that is, shifts to the normal mode 53 (Step S5).

As such, the emphasis display mode 54 is canceled when the operator 60 does not slide. Thus, in Embodiment 1, the emphasis display mode 54 is automatically canceled when the user finishes a scrolling operation for finding out a target image.

FIG. 13 illustrates a relationship between the user operation detected by the operation detector 50 and output by the display 16. The horizontal axis of FIG. 13 indicates time. The vertical axis of FIG. 13 indicates, from the top, a mode state (the normal mode 53 or the emphasis display mode 54), the operation detected by the operation detector 50, and output by the display 16.

As illustrated in FIG. 13, when the operation detector 50 detects sliding of the operator 60 at a time b, the normal mode 53 is shifted to the emphasis display mode 54 and an emphaseized image is prominently displayed (an image is highlighted). Furthermore, the display controller 51 causes the display screen 40 to be scrolled, based on the sliding detected by the operation detector 50.

When the operation detector 50 does not detect the sliding at a time c, the display controller 51 cancels the emphasis display mode 54, and ends the scrolling of the display screen 40 that has been performed based on the sliding.

As such, the display controller 51 determines whether or not to maintain the emphasis display mode 54 in which the emphaseized image 42 is prominently displayed, based on the sliding for scrolling the display screen 40 according to Embodiment 1. Thus, the user can prominently display the emphaseized image 42 by sliding while scrolling of the display screen 40. As a result, the user can easily select a desired image and the usability of the electronic apparatus 1 will be improved, even when the display target image 41 includes many images.

[Switching Between Modes: Embodiment 2]

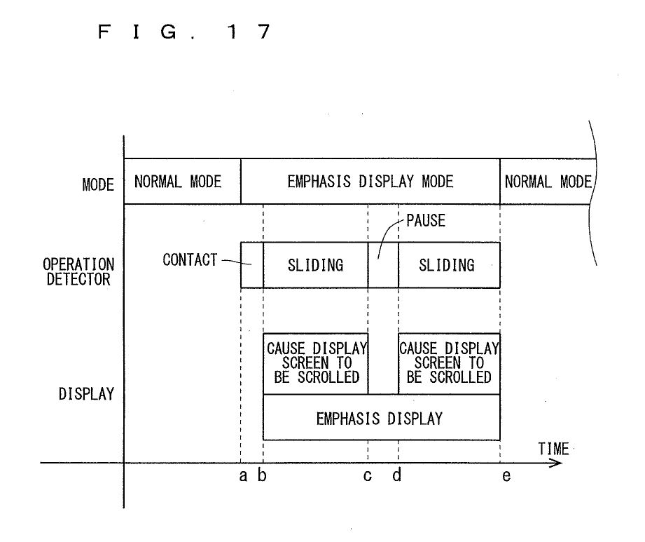

FIG. 14 illustrates a flowchart of processes performed by the display controller 51 in the switching between modes according to Embodiment 2. The normal mode 53 is shifted to the emphasis display mode 54, when the operation detector 50 detects the sliding according to Embodiment 1 whereas when the operation detector 50 detects contact of an operator according to Embodiment 2.

First, the display controller 51 controls display on the display 16 in the normal mode 53 (start). Then, the display controller 51 checks a contact state of the operator 60 with the display 16, based on a result of the detection by the operation detector 50 (Step S6). When the operation detector 50 does not detect the contact of the operator 60 with the display 16 (No at Step S6), the process at Step S6 will be repeated until the operation detector 50 detects the contact.

Conversely, when the operation detector 50 detects the contact of the operator 60 with the display 16 (Yes at Step S6), the display controller 51 shifts from the normal mode 53 to the emphasis display mode 54 (Step S7).

Since the display controller 51 shifts to the emphasis display mode 54 when the operation detector 50 detects start of an operation while detecting no operation on the display 16, the emphaseized image 42 can be prominently displayed before a scrolling operation according to Embodiment 2. Thus, the user can soon easily find out a desired image, and the usability of the electronic apparatus 1 will be further improved.

Next, the display controller 51 checks whether or not the operator 60 starts sliding, based on a result of the detection by the operation detector 50 (Step S8). When the operation detector 50 detects start of the sliding (Yes at Step S8), the display controller 51 causes the display screen 40 to be scrolled, based on the sliding detected by the operation detector 50 (Step S9). Then, the display controller 51 checks whether or not the operator 60 continues to slide, based on a result of the detection by the operation detector 50 (Step S3). When the operation detector 50 continues to detect the sliding (Yes at Step S3), the display controller 51 maintains the emphasis display mode 54 (Step S10), and returns to Step S9. Conversely, when the operation detector 50 does not continue to detect the sliding, that is, when the operation detector 50 detects the end of the sliding (No at Step S3), the display controller 51 cancels the emphasis display mode 54 (Step S5).

When the operation detector 50 does not detect start of the sliding (No at Step S8), the display controller 51 determines whether or not the operator 60 is in non-contact with the display 16, based on a result of the detection by the operation detector 50 (Step S11). The state where the operator 60 is in non-contact with the display 16 herein means that the operation detector 50 (the touch panel 18) does not detect the operator in contact with or in close proximity to the display 16 (display region 2a). When the operation detector 50 detects that the operator 60 is in non-contact with the display 16 (Yes at Step S11), the display controller 51 cancels the emphasis display mode 54 (Step S5). Conversely, when the operation detector 50 detects that the operator 60 is in contact with the display 16 (No at Step S11), the display controller 51 returns to Step S8.

Even when the operation detector 50 does not detect start of the sliding through Steps S8 and S11, the emphasis display mode 54 is not canceled until the operator 60 becomes in non-contact with the display 16. Thus, the user can start a scrolling operation at his/her own pace. As a result, the usability of the electronic apparatus 1 will be further improved.

FIG. 15 illustrates a relationship between the user operation detected by the operation detector 50 and output by the display 16 according to Embodiment 2.

As illustrated in FIG. 15, when the operation detector 50 detects that the operator 60 is in contact with the display 16 at a time a, the display controller 51 shifts from the normal mode 53 to the emphasis display mode 54. Then, when the operation detector 50 detects the sliding of the operator 60 at a time b, the display controller 51 causes the display screen 40 to be scrolled, based on the sliding detected by the operation detector 50. Thus, the user can check the emphaseized image that is prominently displayed, from the contact of the operator 60 with the display 16 to start of the sliding (in other words, from the time a to the time b).

[Switching Between Modes: Embodiment 3]

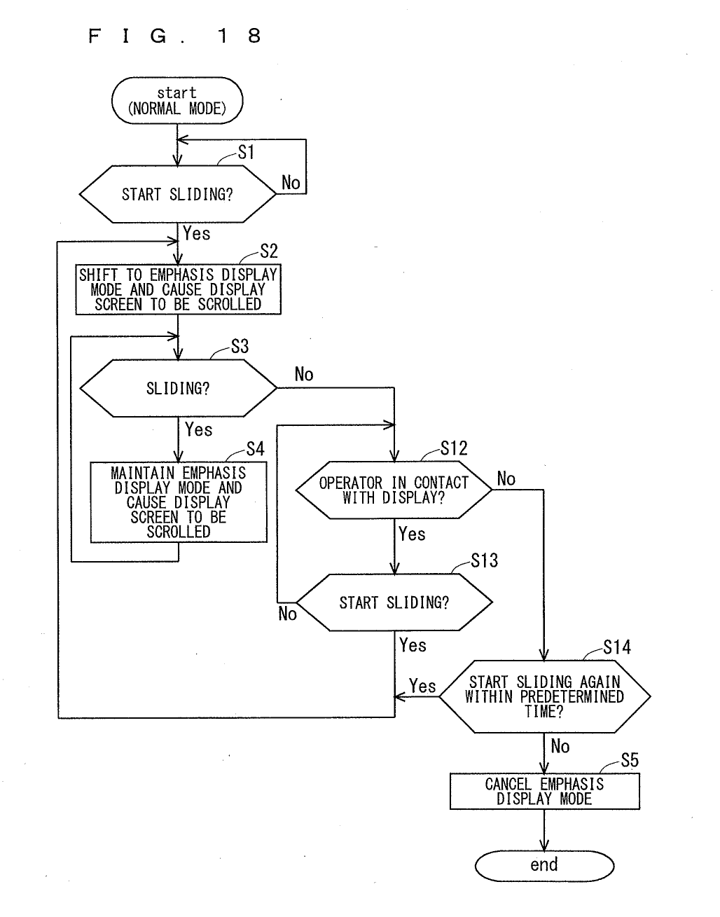

FIG. 16 illustrates a flowchart of processes performed by the display controller 51 in the switching between modes according to Embodiment 3. When the operation detector 50 does not detect the sliding in the emphasis display mode 54, the display controller 51 cancels the emphasis display mode 54 according to Embodiment 1. In contrast, when the operation detector 50 detects that the operator 60 is in non-contact with the display 16, the display controller 51 cancels the emphasis display mode 54 according to Embodiment 3.

The processes at Steps S1 to S4 in FIG. 16 are identical to those in the switching between modes according to Embodiment 1 (Steps S1 to S4 in FIG. 12). Thus, the description will be omitted.

When the operation detector 50 does not detect the sliding at Step 3 (No at Step 3), the display controller 51 checks whether or not the operator 60 is in contact with the display 16, based on a result of the detection by the operation detector 50 (Step S12).

When the operator 60 is in contact with the display 16 (Yes at Step S12), the display controller 51 checks whether or not the operator 60 starts sliding, based on a result of the detection by the operation detector 50 (Step S13). When the operation detector 50 detects that the operator 60 starts sliding (Yes at Step S13), the display controller 51 returns to Step S2, maintains the emphasis display mode 54, and causes the display screen 40 to be scrolled, based on the sliding. Conversely, when the operation detector 50 does not detect the start of the sliding (No at Step S13), the display controller 51 returns to Step S12, and checks whether or not the operator 60 is in contact with the display 16.

In contrast, when the operator 60 is not in contact with the display 16 at Step S12 (No at Step S12), the display controller 51 cancels the emphasis display mode 54 (Step S5). In other words, once the display controller 51 shifts to the emphasis display mode 54, it does not cancel the emphasis display mode 54 until the operator 60 becomes in non-contact with the display 16.

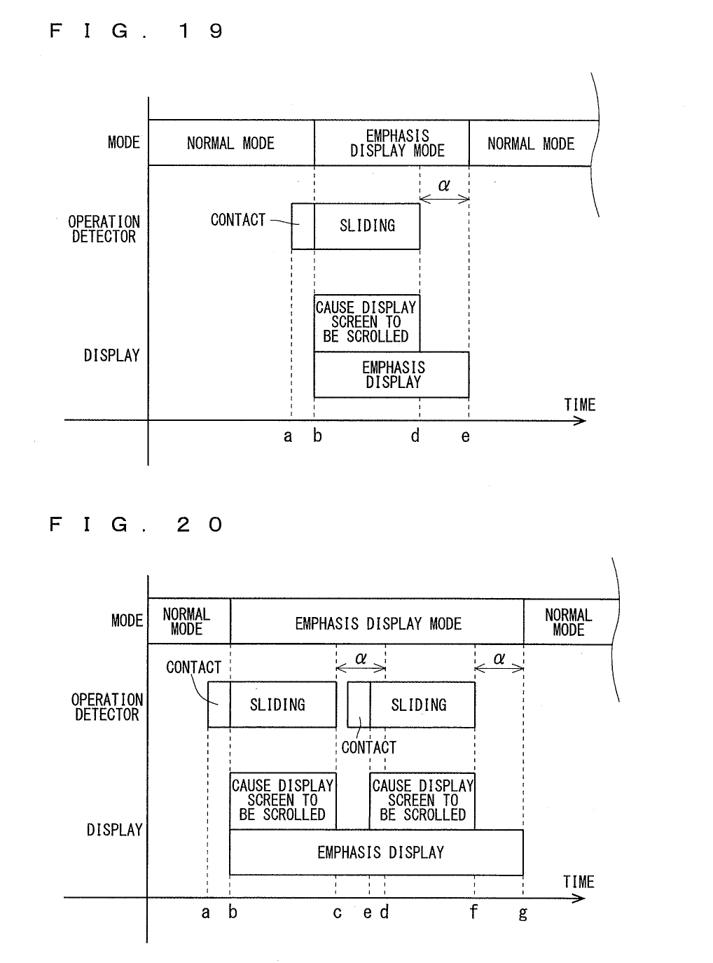

FIG. 17 illustrates a relationship between the user operation detected by the operation detector 50 and output by the display 16, according to Embodiment 3. As illustrated in FIG. 17, even when the operator 60 suspends the sliding while being in contact with the display 16 from a time c to a time d, the emphasis display mode 54 is never canceled according to Embodiment 3.

In the switching between modes according to Embodiment 3, when the operation detector 50 detects that the operator 60 is in non-contact with the display 16, the display controller 51 cancels the emphasis display mode 54. Thus, even when the user suspends the sliding to confirm the image, the emphasis display mode 54 is never canceled. When the operator 60 is not in contact with the display 16 (that is, when the user completely finishes searching for an image), the emphasis display mode 54 is canceled. As a result, the usability of the electronic apparatus 1 will be further improved.

[Switching Between Modes: Embodiment 4]

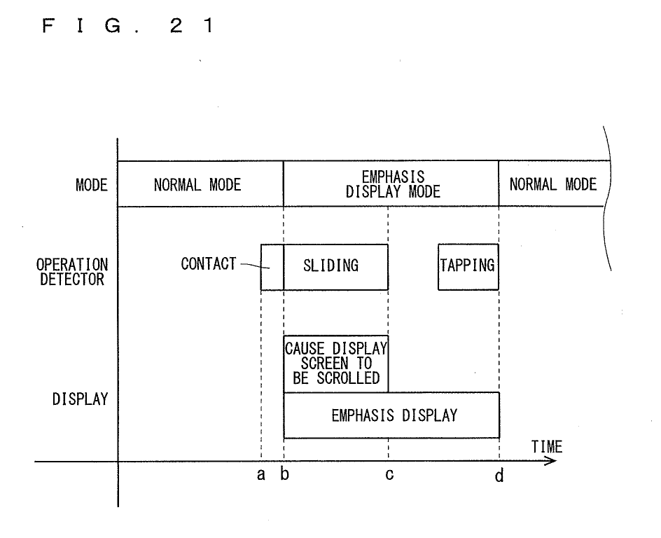

FIG. 18 illustrates a flowchart of processes performed by the display controller 51 in the switching between modes according to Embodiment 4. When the operator 60 is in non-contact with the display 16, the display controller 51 cancels the emphasis display mode 54 according to Embodiment 3. In contrast, after the operator 60 is in non-contact with the display 16 and when the operation detector 50 does not detect the sliding again within a predetermined time, the display controller 51 cancels the emphasis display mode 54 according to Embodiment 4.

The processes at Steps S1 to S4, S12, and S13 in FIG. 18 are identical to Steps S1 to S4, S12, and S13 in FIG. 16 in the switching between modes according to Embodiment 3. Thus, the description will be omitted.

When the operator 60 is not in contact with the display 16 at Step S12 (No at Step S12), the display controller 51 checks whether or not the operator 60 starts sliding on the display 16 again within a predetermined time, based on a result of the detection by the operation detector 50 (Step S14). In other words, it is confirmed at Step S14 whether or not the operator 60 starts sliding again within a predetermined time between the end of the previous sliding and a point in time when the operator 60 is not in contact with the display 16. Put it differently, it is confirmed at Step S14 whether or not the operator 60 starts sliding again within a predetermined time, after the previous sliding since no operation is performed on the display 16.

When the operator 60 starts sliding on the display 16 again within a predetermined time (Yes at Step S14), the display controller 51 returns to Step S2, maintains the emphasis display mode 54, and causes the display screen 40 to be scrolled based on the sliding. Conversely, when the operator 60 does not start sliding on the display 16 again within a predetermined time (No at Step S14), the display controller 51 cancels the emphasis display mode 54 (Step S5).

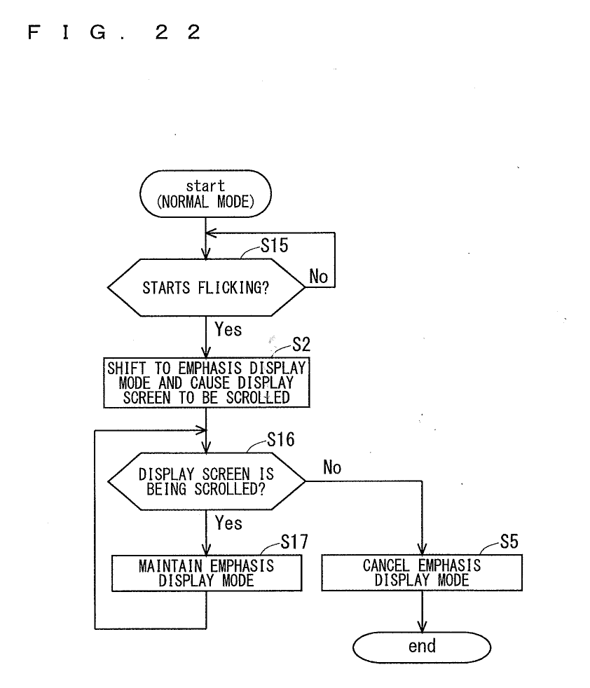

FIGS. 19 and 20 illustrate a relationship between the user operation detected by the operation detector 50 and output by the display 16 according to Embodiment 4.

As illustrated in FIG. 19, even when the operator 60 suspends sliding on the display 16 and is not in contact with the display 16 at a time d, the display controller 51 maintains the emphasis display mode 54 for a lapse of a predetermined time α (a time e=the time d+predetermined time α) according to Embodiment 4.

Furthermore, as illustrated in FIG. 20, the display controller 51 maintains the emphasis display mode 54 for a lapse of the predetermined time α from a time c at which the operator 60 suspends sliding on the display 16 and is not in contact with the display 16, that is, between the time c and a time d, when the operator 60 is again in contact with the display 16 and starts sliding. Furthermore, the display controller 51 maintains the emphasis display mode 54 for a lapse of the predetermined time α from a time fat which the operator 60 suspends sliding and is not in contact with the display 16 for the second time. Specifically, the display controller 51 maintains the emphasis display mode 54 between the time b at which the operator 60 first starts sliding and a time g, in the example of FIG. 20.

In the switching between modes according to Embodiment 4, even when the user cannot display an application-relevant image that is being searched on the display 16 by one scrolling operation, the user can continue to search for the target image by performing the scrolling operation again within the predetermined time α, without changing the image selected as the emphaseized image 42. As a result, the usability of the electronic apparatus 1 will be further improved.

[Switching Between Modes: Embodiment 5]

The display controller 51 cancels the emphasis display mode 54 based on the sliding of the operator 60 according to Embodiments 1 to 4. According to Embodiment 5, the emphasis display mode 54 may be canceled when the operation detector 50 detects tapping of the operator 60 in a region other than images.

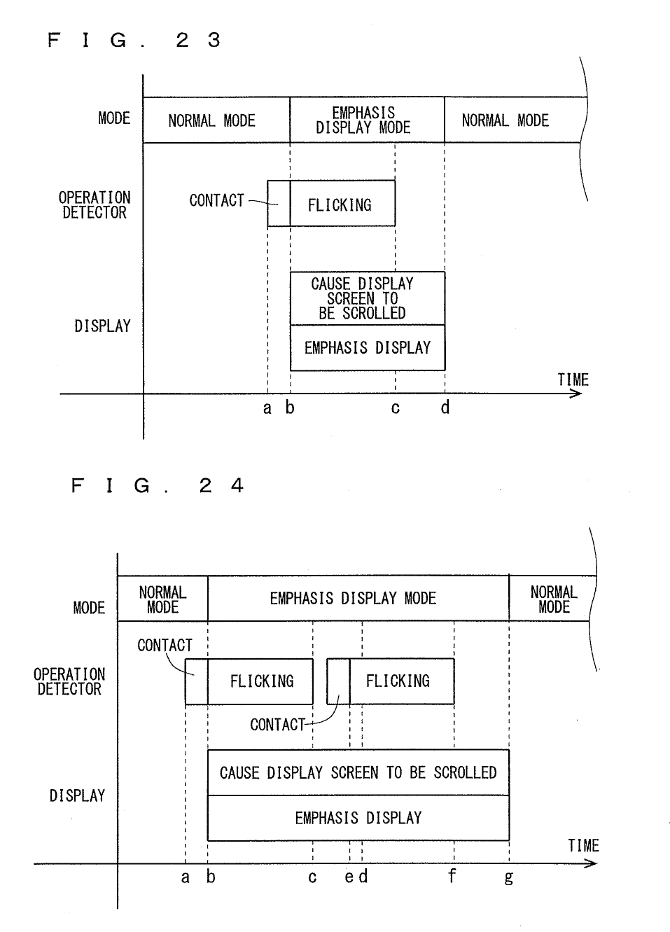

FIG. 21 illustrates a relationship between the user operation detected by the operation detector 50 and output by the display 16 according to Embodiment 5. As illustrated in FIG. 21, once the display controller 51 shifts to the emphasis display mode 54 at the time b, it maintains the emphasis display mode 54 until the operation detector 50 detects tapping in a region other than images in the display screen 40 at a time d.

Since the tapping on an image included in the display screen 40 starts the application corresponding to the image, the initial screen mode ends. Furthermore, during the sliding between the times b and c, when the operation detector 50 detects the tapping in the region other than images in the display screen 40, the display controller 51 cancels the emphasis display mode 54 at a time when the operation detector 50 detects the tapping.

As such, when the display controller 51 shifts to the emphasis display mode 54 in the switching between modes according to Embodiment 5, it maintains the emphasis display mode 54 until the operation detector 50 detects the tapping. Thus, the user can easily cancel the emphasis display mode 54 with a desired timing according to Embodiment 5. As a result, the usability of the electronic apparatus 1 will be further improved.

[Switching Between Modes: Embodiment 6]

According to Embodiment 6, when the operation detector 50 detects start of a new operation other than the scrolling operation on the display 16, the display controller 51 cancels the emphasis display mode 54.

Examples of the operation other than the scrolling operation according to Embodiment 6 include long touching other than the tapping as described above. The long touching is an operation in which the operator 60 moves away from the display 16 after being in contact with the display 16 for a predetermined time or longer. The long touching on the display 16 allows the user to display, for example, a menu screen on the display 16. The operation other than the scrolling operation is not performed when the user searches for an image. In other words, when start of an operation other than the scrolling operation is detected, it is probable that the user has finished searching for an image and has started the next operation.

Furthermore, unlike Embodiment 5 in which the emphasis display mode 54 is canceled upon detection of the tapping in the region other than images in the display screen 40, the emphasis display mode 54 is canceled upon detection of an operation other than the scrolling operation, regardless of which region in the display screen 40 the operation is performed, according to Embodiment 6. As such, after the user searches for an image (performs a scrolling operation), performing any operation on a region other than images in the display screen 40 allows the user to cancel the emphasis display mode 54.

According to Embodiment 6, the emphasis display mode 54 is canceled when the operation detector 50 detects start of a new operation other than the scrolling operation on the display 16. Therefore, the emphasis display mode 54 can be canceled after the user finishes (or suspends) searching for an image and starting the next operation. Put it differently, the emphasis display mode 54 is maintained until the user starts an operation other than the scrolling operation on the display 16 according to Embodiment 6. As a result, the usability of the electronic apparatus 1 will be further improved.

[Switching Between Modes: Embodiment 7]

The display controller 51 switches between the normal mode 53 and the emphasis display mode 54, based on the sliding of the operator 60 that is detected by the operation detector 50 according to Embodiments 1 to 4. In contrast, the display controller 51 may switch between the normal mode 53 and the emphasis display mode 54, based on not the sliding on the display 16 but the scrolling of the display screen 40 as according to Embodiment 7. The switching between modes according to Embodiment 7 will be described by exemplifying the flicking as the scrolling operation hereinafter.

FIG. 22 illustrates a flowchart of processes performed by the display controller 51 in the switching between modes according to Embodiment 7. First, the display controller 51 controls display on the display 16 in the normal mode 53 (start). Then, the display controller 51 checks whether or not the operator 60 starts flicking, based on a result of the detection by the operation detector 50 (Step S15). When the operation detector 50 does not detect start of the flicking (No at Step S15), the operation detector 50 will repeat the process at Step S15 until detecting start of the flicking. When the operation detector 50 detects start of the flicking (Yes at Step S15), the display controller 51 shifts from the normal mode 53 to the emphasis display mode 54, and scrolls the display screen 40 based on the flicking detected by the operation detector 50 (Step S2).

Next, the display controller 51 checks whether or not the display screen 40 is being scrolled (Step S16). When the display screen 40 is being scrolled (Yes at Step S16), the display controller 51 maintains the emphasis display mode 54 (Step S17), and returns to Step S16. Conversely, when the display screen 40 is not being scrolled (No at Step S16), the display controller 51 cancels the emphasis display mode 54 (Step S5).

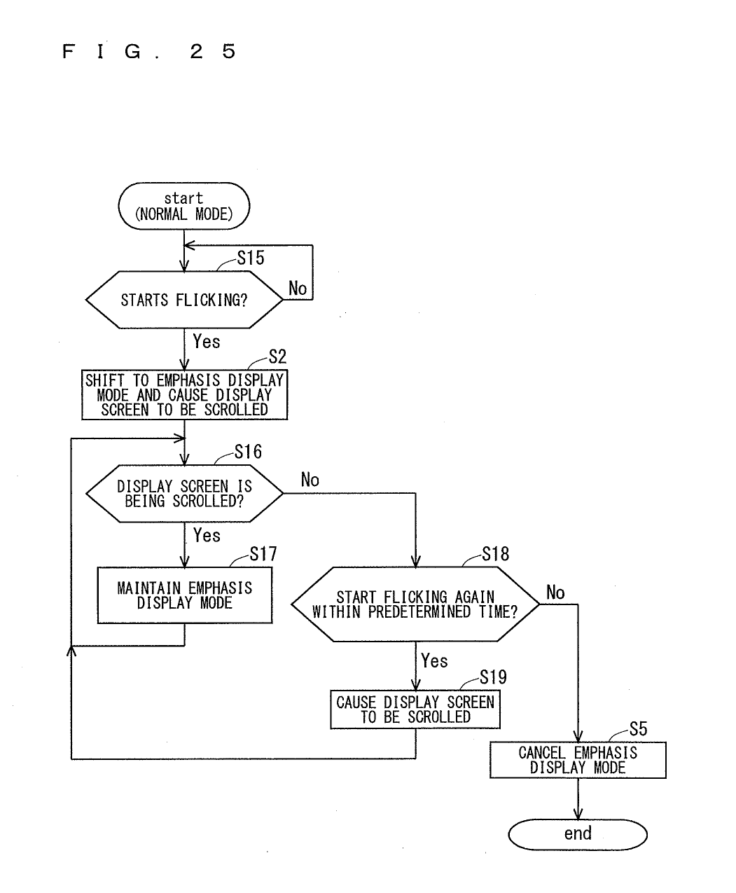

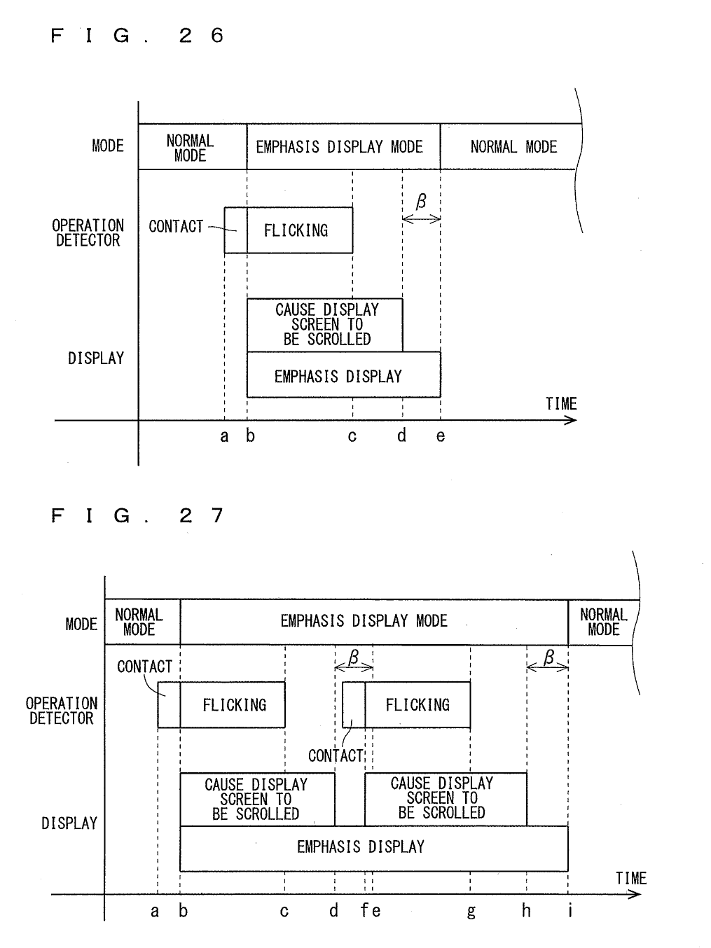

FIGS. 23 and 24 illustrate a relationship between the user operation detected by the operation detector 50 and output by the display 16 in the switching between modes according to Embodiment 7.

As illustrated in FIG. 23, the emphasis display mode 54 is not canceled even after the flicking ends at a time c, but is canceled after the scrolling ends in the display screen 40 at a time d, in the switching between modes according to Embodiment 7.

Furthermore, as illustrated in FIG. 24, when the operation detector 50 detects flicking again between the times c and d, that is, between the end of the first flicking and the end of the scrolling of the display screen 40 by the first flicking, the display controller 51 maintains the emphasis display mode 54. Specifically, the display controller 51 maintains the emphasis display mode 54 between the times b and g, that is, from start of the first flicking till the end of the scrolling of the display screen 40 by the second flicking.

As such, the emphasis display mode 54 is canceled based on whether or not the display screen 40 is being scrolled, in the switching between modes according to Embodiment 7. Thus, even when the display screen 40 is scrolled by flicking, that is, when the display screen 40 is again scrolled after the first scrolling operation, the emphasis display mode 54 is not canceled until the end of the scrolling of the display screen 40. Thus, when the user performs a scrolling operation on the electronic apparatus 1 to scroll the display screen 40, that is, when it seems that the user searches for a target image, the emphaseized image can be prominently displayed. Thus, the user can easily select a desired image. As a result, the usability of the electronic apparatus 1 will be further improved.

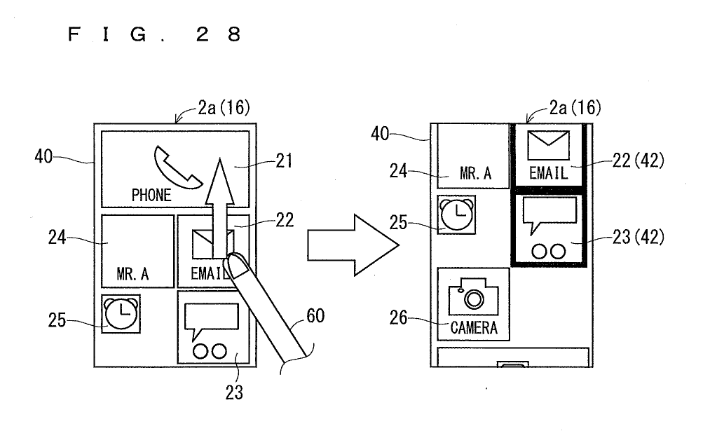

The display controller 51 can switch between the normal mode 53 and the emphasis display mode 54 based on the scrolling of the display screen 40, even when the operator 60 slides as the scrolling operation according to Embodiments 1 to 5. Specifically, the display controller 51 can switch between the normal mode 53 and the emphasis display mode 54 based on the scrolling of the display screen 40, by performing Step S16 in FIG. 25, instead of Step S3 in FIGS. 12, 14, 16, and 18.

[Switching Between Modes: Embodiment 8]

FIG. 25 illustrates a flowchart of processes performed by the display controller 51 in the switching between modes according to Embodiment 8. The display controller 51 cancels the emphasis display mode 54 upon end of the scrolling of the display screen 40 according to Embodiment 7, whereas the display controller 51 cancels the emphasis display mode 54 when the operation detector 50 does not detect flicking again within a predetermined time after the end of scrolling of the display screen 40 according to Embodiment 8.

Since the processes at Steps S15, S2, S16, and S17 in FIG. 25 are the same as those in FIG. 22 according to Embodiment 7, the description thereof will be omitted.

When the display screen 40 is not being scrolled (No at Step S16), the display controller 51 checks whether or not the operator 60 starts flicking again within a predetermined time, based on a result of the detection by the operation detector 50 (Step S18). When the operation detector 50 detects flicking again within the predetermined time (Yes at Step S18), the display controller 51 causes the display screen 40 to be scrolled, based on the flicking (Step S19), and returns to Step S16. Conversely, when the operation detector 50 does not detect flicking again within the predetermined time (No at Step S18), the display controller 51 cancels the emphasis display mode 54 (Step S5).

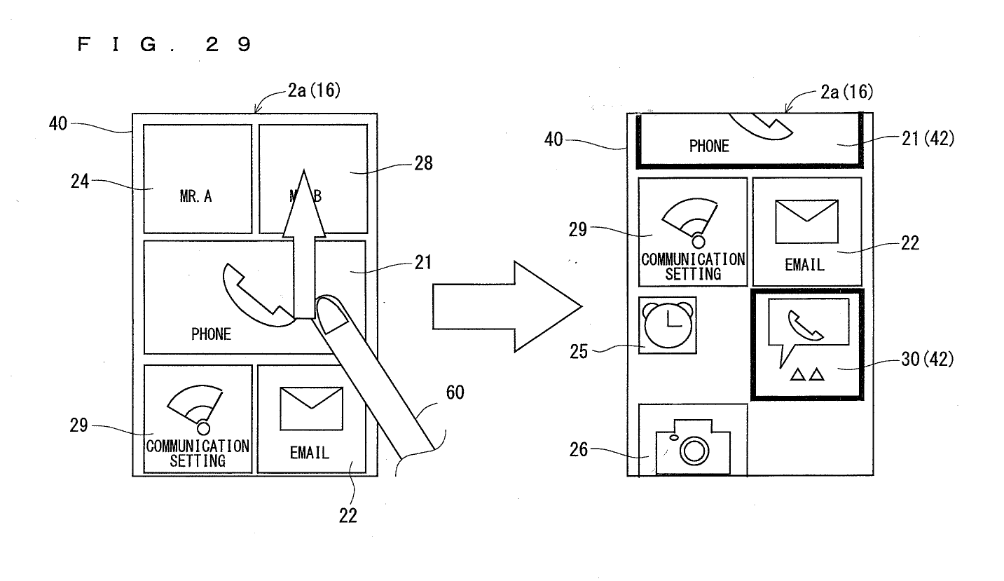

FIGS. 26 and 27 illustrate a relationship between the user operation detected by the operation detector 50 and output by the display 16 in the switching between modes according to Embodiment 8.

As illustrated in FIG. 26, the emphasis display mode 54 is not canceled even after end of the scrolling of the display screen 40 at a time d, and is canceled at a time e after a lapse of a predetermined time β from the time d at which the scrolling of the display screen 40 ends, according to Embodiment 8.

Furthermore, as illustrated in FIG. 27, when the operation detector 50 detects the flicking again during a lapse of the predetermined time β from the time d at which the scrolling of the display screen 40 ends, that is, between the times d and e, the display controller 51 maintains the emphasis display mode 54. In other words, the display controller 51 maintains the emphasis display mode 54 until the lapse of the predetermined time β from the end of the second scrolling of the display screen 40, that is, between the time b at which the first flicking starts and a time i at which the predetermined time β has lapsed since the end of the second scrolling of the display screen 40.

As illustrated in FIG. 26, the emphasis display mode 54 is maintained until the predetermined time β has lapsed since the end of the scrolling of the display screen 40 even after the end of the scrolling, in the switching between modes according to Embodiment 8. Thus, the user can continue to search for a target image by flicking until a lapse of the predetermined time β even after the scrolling of the display screen 40 is suspended, without changing the image selected as the emphaseized image 42. Thus, the usability of the electronic apparatus 1 will be further improved.

The display controller 51 may shift to the emphasis display mode 54 when the operation detector 50 detects start of an operation while detecting no operation on the display 16 as according to Embodiment 2, even in the case where the operator 60 flicks as the scrolling operation as according to Embodiments 7 and 8.

[[Selecting Emphaseized Image]]

[Selecting Emphaseized Image: Embodiment 1]

A method for selecting the emphaseized images 42 will be described hereinafter. In selecting the emphaseized image 42 according to Embodiment 1, an image from which the scrolling operation has started and an image related to the image from which the scrolling operation has started are selected as the emphaseized images 42. The display controller 51 selects the emphaseized image 42 based on a result of the detection by the operation detector 50.

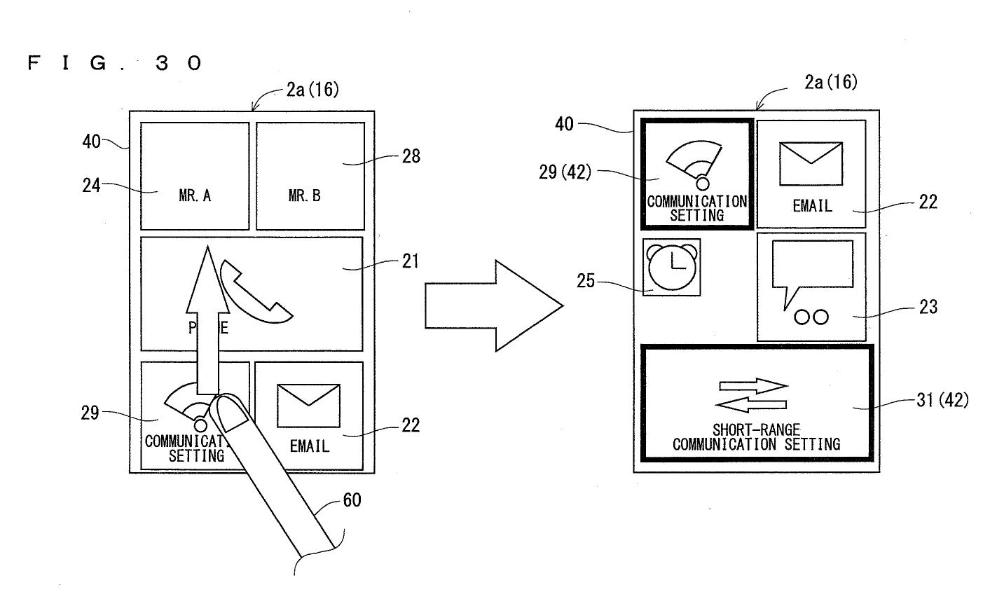

FIGS. 28 to 30 illustrate display examples of the display 16 according to Embodiment 1. In FIGS. 28 to 30, the display 16 before the scrolling operation is illustrated to the left, and the display 16 after the scrolling operation is illustrated to the right.

As illustrated in FIG. 28, the images 21, 22, 23, 24, and 25 are displayed on the display 16 before the scrolling operation. Then, the operator 60 performs the scrolling operations from the image 22 corresponding to the email application. As illustrated in FIG. 28 to the right, for example, the image 22 from which the scrolling operation has started and which corresponds to the email application, and the image 23 corresponding to the instant message application related to the email application are selected as the emphaseized images 42. Since the email application and the instant message application have in common a function of transmitting and receiving text information, that is, belong to the same category, the image 22 corresponding to the email application and the image 23 corresponding to the instant message application are images related to each other.

The associations between the images are predetermined and stored in the storage 13 of the electronic apparatus 1. Furthermore, the image from which the scrolling operation has started (the image 22 in the example of FIG. 28) does not have to be selected as the emphaseized image 42 but only the image related to the image from which the scrolling operation has started may be selected as the emphaseized image 42.

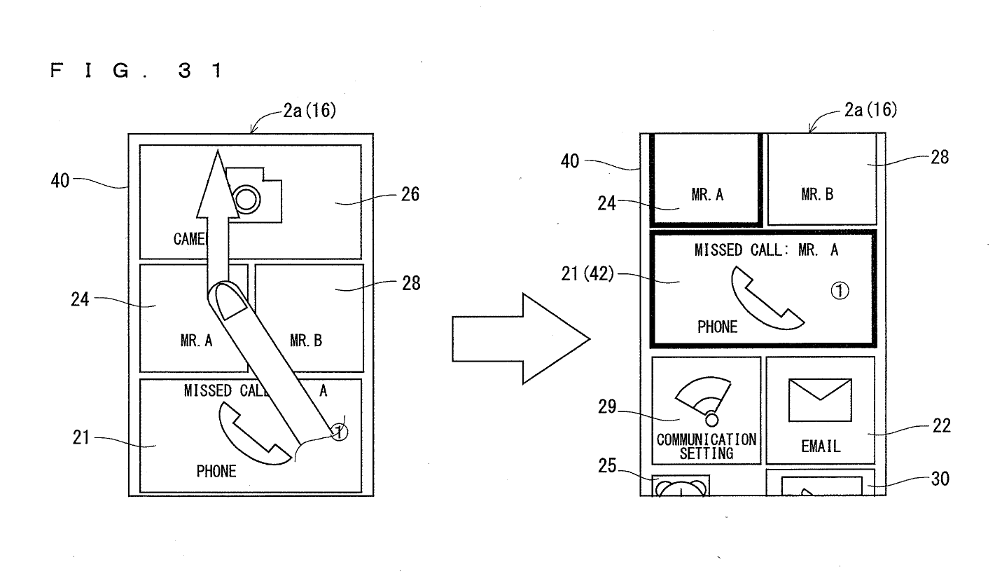

FIG. 29 illustrates that the operator 60 has performed the scrolling operation from the image 21 corresponding to the phone application. As illustrated to the right of FIG. 29, the image 21 from which the scrolling operation has started and an image 30 related to the image 21 are selected as the emphaseized images 42. The image 30 is a communication application for voice communication using the Internet. Since the phone application and the communication application have in common a voice communication function, the image 21 corresponding to the phone application and the image 30 corresponding to the communication application are images related to each other.

Furthermore, as illustrated in FIG. 30, the images 24, 28, 21, 22, and 29 are displayed on the display 16 before the scrolling operation. The image 29 is an image corresponding to a wireless LAN setting application for setting a wireless LAN. When the operator 60 performs the scrolling operation from the image 29 corresponding to the wireless LAN setting application as illustrated to the left of FIG. 30, the image 29 from which the scrolling operation has started and an image 31 related to the image 29 are selected as the emphaseized images 42, as illustrated to the right of FIG. 30. The image 31 is a short-range communication setting application for setting infrared communications. Since the wireless LAN setting application and the short-range communication setting application have in common a function of setting up communication, the image 29 and the image 31 are images related to each other.

In the selecting of an emphaseized image according to Embodiment 1, an image from which the scrolling operation has started, and an image corresponding to an application related to the application corresponding to the image from which the scrolling operation has started are selected as the emphaseized images 42. Thus, for example, when the user finds an image related to a target image, the target image can be selected as the emphaseized image 42 by performing a scrolling operation from the related image.

[Selecting Emphaseized Image: Embodiment 2]

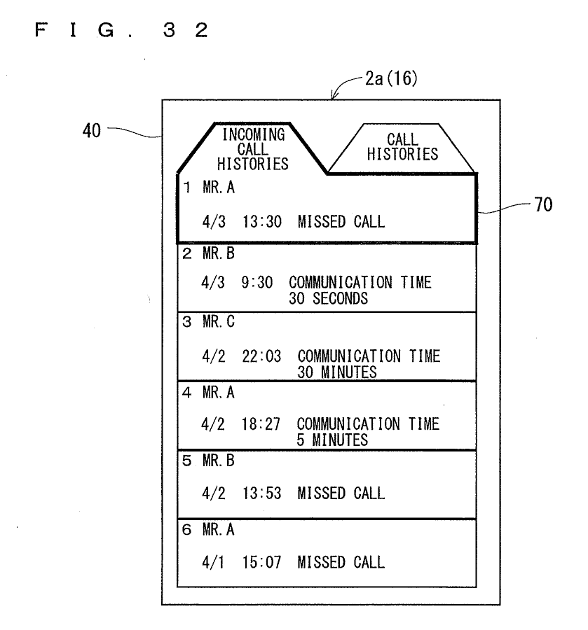

Selecting the emphaseized images 42 when an application corresponding to an image from which the scrolling operation has started is an application for providing certain information (displaying the information on the display 16) will be described hereinafter. Here, the display controller 51 selects, as the emphaseized images 42, the image from which the scrolling operation has started, and an image corresponding to an application for providing, to the user, information including unread information including certain information provided by the application corresponding to the image. FIGS. 31 and 33 illustrate display examples of the display 16 according to Embodiment 2.

In the example of FIG. 31, the display screen 40 before the scrolling operation includes the images 26, 24, 28, and 21. The image 24 is an image corresponding to a phone directory application providing a name of Mr. A registered in the phone directory and information associated with the name of Mr. A in the phone directory. The image 21 is the image corresponding to the phone application. Furthermore, a part of the functions in the phone application (incoming call function) enables the user to obtain information on a missed call from Mr. A (missed call information). The image 21 displays the information on the missed call. In FIG. 31, the image 21 displays the name of Mr. A and the information indicating one missed call.

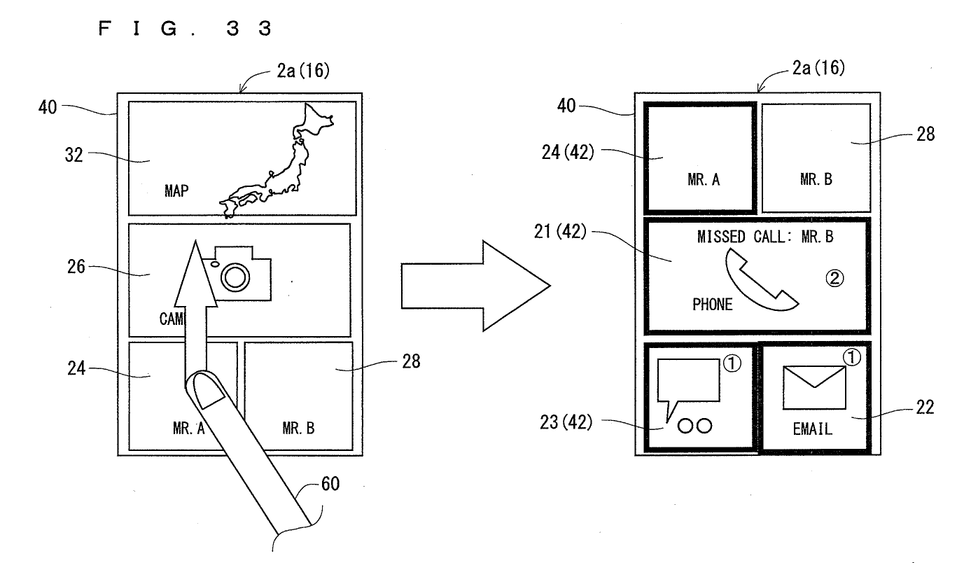

When the image 21 that displays the missed call information is tapped, the incoming call histories including the missed call information and the received call histories are provided to the user (displayed on the display 16) as illustrated in FIG. 32. Examples of the information provided by the phone application include names, incoming times, missed calls, and communication times as illustrated in FIG. 32. Furthermore, unread missed call information is prominently displayed as illustrated in a region 70 of FIG. 32.

According to Embodiment 2, when the scrolling operation has started from the image 24 as illustrated in FIG. 31 to the left, the display controller 51 selects, as the emphaseized images 42, the image 24 from which the scrolling operation has started, and the image 21 corresponding to the phone application for providing, to the user, the incoming call histories including the unread missed call information including the name of Mr. A.

Furthermore, as illustrated in FIG. 33, when the scrolling operation has started from the image 24 corresponding to the phone directory application for providing the name of Mr. A and information associated with the name of Mr. A, the display controller 51 selects, as the emphaseized images 42, for example, the image 24 from which the scrolling operation has started, and the images 21, 22, and 23. The image 21 is the image corresponding to the phone application. Furthermore, the incoming call function in the phone application enables the user to obtain the missed call information of Mr. A and Mr. B. The image 21 displays the information indicating the name of Mr. B who is the caller of the latest missed call and another two missed calls. The image 22 is the image corresponding to the email application. The receiving function in the email application enables the user to obtain information on an incoming email from Mr. A. The image 22 displays the number of incoming emails. Since the image 22 is smaller in size, it displays information on not the senders of the incoming emails but only the number of the incoming emails. The image 23 is the image corresponding to the instant message application. Furthermore, the receiving function in the instant message application enables the user to obtain information on an incoming message from Mr. A. The image 23 displays the number of the incoming messages.

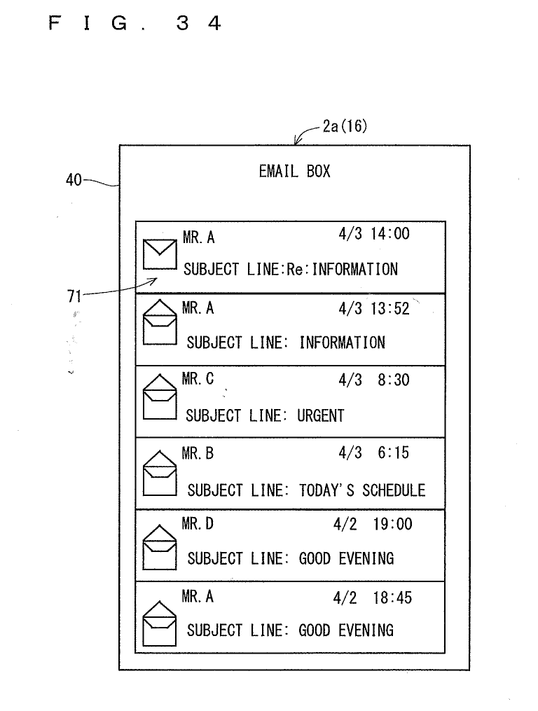

When the image 22 that displays the information on the incoming email is tapped, information on the previously received emails (received-email information) is provided to the user for each of the emails (displayed on the display 16) as illustrated in FIG. 34. Examples of the information to be provided by the email application include names, incoming times, and titles of received emails as illustrated in FIG. 34. Furthermore, for example, an unread icon 71 is placed as the unread received-email information, that is, information on the incoming emails to distinguish it from the read received-email information as illustrated in FIG. 34.

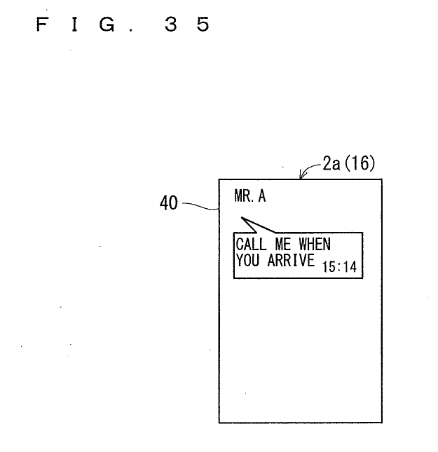

Furthermore, when the image 23 that displays information on the incoming message is tapped, the information on the incoming message is provided (displayed on the display 16) as illustrated in, for example, FIG. 35. The information on an incoming message equates to information on the incoming message that is unread (unread received message information). Examples of the information to be provided by the instant message application include a name, a message, and an incoming time as illustrated in FIG. 35. Since a message to be transmitted and received by executing the instant message application is limited to a short sentence and it does not take long to check the message, the message is sometimes displayed with no distinction between unread and read messages.

None of the images 21, 22, and 23 in FIG. 33 displays the name of Mr. A. However, each of the applications corresponding to the images 21, 22, and 23 provides information including unread information including the name of Mr. A. Thus, when the scrolling operation has started from the image 24 as illustrated in FIG. 33 to the left, the display controller 51 selects the images 21, 22, and 23 as the emphaseized images 42.

According to Embodiment 2, when the scrolling operation has started from an image corresponding to an application that provides certain information, the display controller 51 selects, as the emphaseized image 42, an image corresponding to an application that provides information including unread information including the certain information. Thus, the user can easily know the presence or absence of unread information including certain information, for example, unread information including a name of a specific person. The image from which the scrolling operation has started does not have to be selected as the emphaseized image 42 as according to Embodiment 1.

[Selecting Emphaseized Image: Embodiment 3]

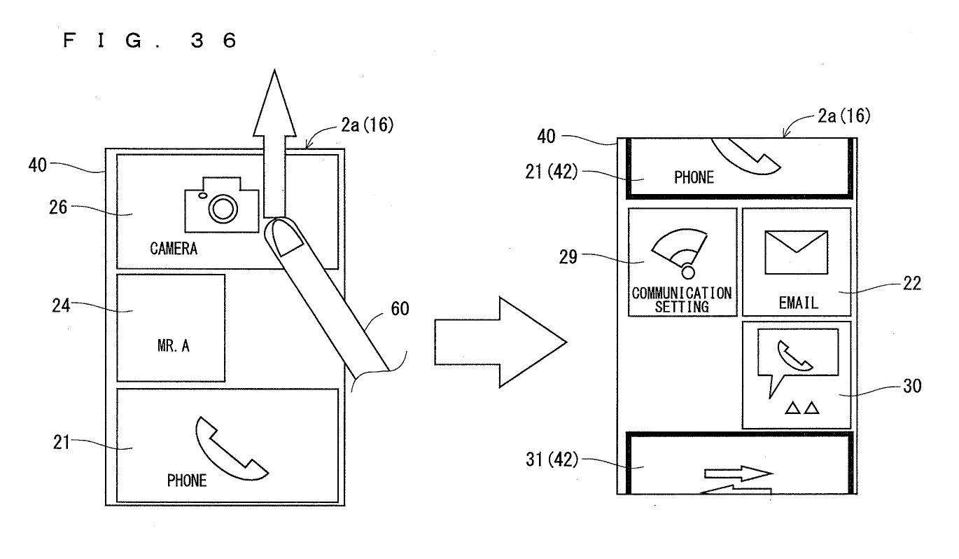

In the selecting of the emphaseized images 42 according to Embodiment 3, an image identical in size to the image from which the scrolling operation has started is selected as the emphaseized image 42. FIG. 36 illustrates a display example of the display 16 according to Embodiment 3.

When the scrolling operation has started from, for example, the image 26 that is the largest among the images in the display screen 40 as illustrated in FIG. 36 to the left, the display controller 51 selects the images 21 and 31 that are the largest among the images as the emphaseized images 42, as illustrated in FIG. 36 to the right.

The image from which the scrolling operation has started may be or may not be selected as the emphaseized image 42.

[Selection of Emphaseized Image: Embodiment 4]

Embodiment 4 describes a case where the emphaseized image 42 does not exist except for the image from which the operation has started. FIG. 37 illustrates a display example of the display 16 according to Embodiment 4.

When the image identical in size to the image from which the scrolling operation starts is selected as the emphaseized image 42, assume that the scrolling operation has started from the image 27 that is the largest in the display screen 40 as illustrated in FIG. 37. When there is no image identical in size to the image 27 in the display target image 41, that is, when the image 27 is only larger than the images arranged in the display target image 41, the display controller 51 displays a message 43 indicating that there is no image corresponding to the emphaseized image 42 as illustrated in FIG. 37 to the right. Furthermore, besides displaying the message 43, the display controller 51 may prohibit or disable the display screen 40 from being scrolled.

As such, when there is no image related to the image from which the scrolling operation has started, the user can know the absence of the image that the user is searching for without actually searching for the image, by notifying a message indicating the absence of the image related to the image from which the scrolling operation has started. Furthermore, even when the scrolling operation has started and there is no image related to the image from which the scrolling operation has started, disabling the display screen 40 from being scrolled negates the need for the user to return the display screen 40 to the original state.

[Selection of Emphaseized Image: Embodiment 5]

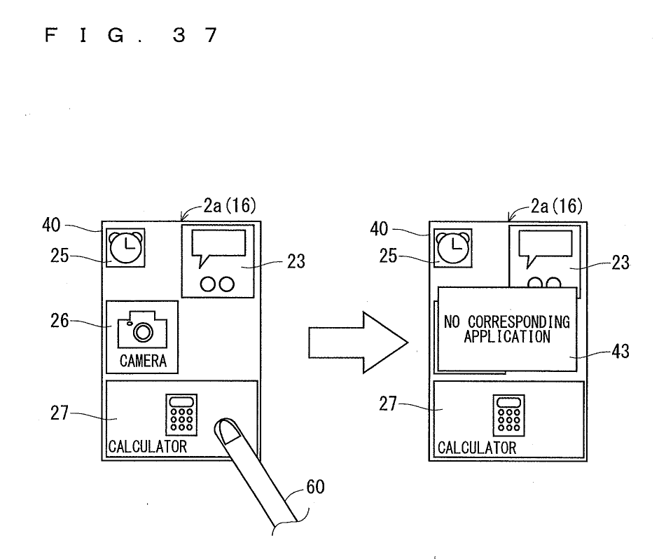

Embodiment 5 will describe selection of the emphaseized images 42 when two of the operators 60 have started the scrolling operation from the respective images (a first image 61 and a second image 62). Here, all the images selected when the scrolling operations have started from the first image 61 and the second image 62 are the emphaseized images 42. FIG. 38 illustrates a display example of the display 16 according to Embodiment 5. Here, when one of the operators 60 has started the scrolling operation from the image corresponding to an application that provides a specific name and information associated with the specific name, the image from which the scrolling operation has started, and the image corresponding to the application that provides information including unread information including the specific name are selected as the emphaseized images 42.

FIG. 38 to the left illustrates that two of the operators 60 have started the scrolling operation from the image 24 (the first image 61) corresponding to the phone application that provides the name of Mr. A and information associated with the name of Mr. A, and from an image 28 (the second image 62) corresponding to a phone application that provides a name of Mr. B and information associated with the name of Mr. B. Here, for example, the images 21, 22, and 30 are selected as the emphaseized images 42 as illustrated in FIG. 38 to the right.

The image 21 is the image corresponding to the phone application. Furthermore, the incoming call function in the phone application enables the user to obtain information on a missed call from Mr. A. The image 21 displays the information on the missed call.

The image 22 is the image corresponding to the email application. Although the image 22 displays only the number of the incoming emails, the receiving function in the email application enables the user to obtain information on the incoming emails from Mr. A and Mr. B.

The image 30 is an image corresponding to a communication application, and displays information on a missed call from Mr. B that is obtained by the incoming call function in the communication application.

In the example of FIG. 38, the images 21 and 22 are selected as the emphaseized images 42 when the scrolling operation has started from the image 24 (the first image 61), and the images 22 and 30 are selected as the emphaseized images 42 when the scrolling operation has started from the image 28 (the second image 62). As a result, the images 21, 22, and 30 are selected as the emphaseized images 42.

[Selection of Emphaseized Image: Embodiment 6]

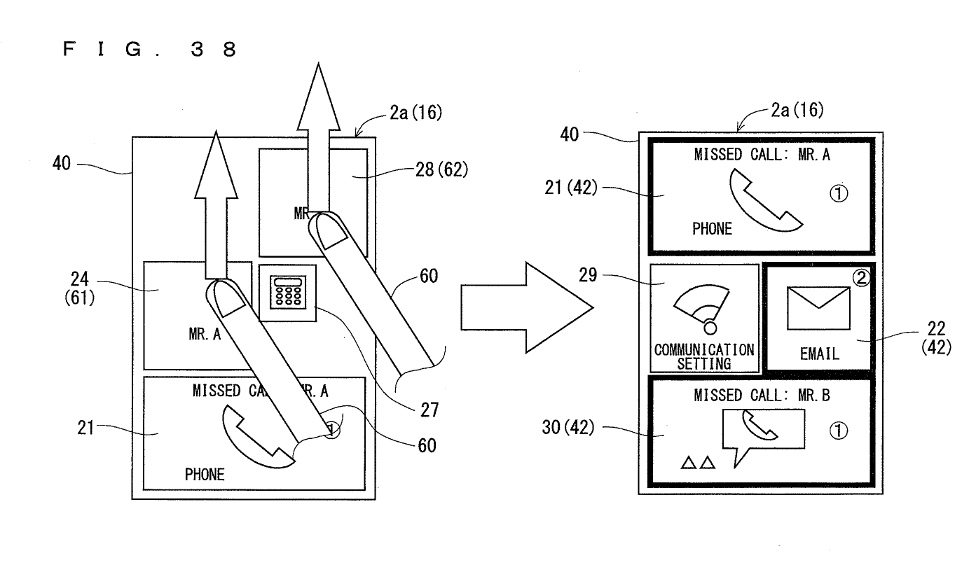

Although the emphaseized images 42 are selected based on an image from which the scrolling operation has started according to Embodiments 1 to 3, and 5, they may be selected based on the number of the operators 60 that perform the scrolling operation. According to Embodiment 6, an image corresponding to an application that provides information including unread information is selected as the emphaseized image 42, when the number of the operators 60 that have performed the scrolling operation is a predetermined number. Examples of the unread information according to Embodiment 6 include information on a missed call in the phone application and information on a schedule to be notified at a specific time by a schedule application. FIG. 39 illustrates a display example of the display 16 according to Embodiment 6.

As illustrated in FIG. 39, when, for example, two of the operators 60 have performed the scrolling operation, the display controller 51 selects, as the emphaseized images 42, the image 22 indicating information on incoming emails, and the image 25 indicating the number of alarms currently set. FIG. 39 exemplifies the scrolling operation with the two operators 60. For example, when three of the operators 60 have performed the scrolling operation, an image corresponding to an application that provides information including unread information may be selected as the emphaseized image 42. Specifically according to Embodiment 6, when the predetermined number of the operators 60 have performed the scrolling operation, the display controller 51 selects, as the emphaseized image 42, the image corresponding to the application that provides information including unread information. The associations between the number of the operators 60 and the emphaseized images 42 to be selected may be arbitrarily defined by the user.

According to Embodiment 6, the user enables the electronic apparatus 1 to select, as the emphaseized image 42, an image corresponding to the application that provides information including unread information, by merely changing the number of the operators 60 that perform the scrolling operation. Thus, the user can easily know the image corresponding to the application containing unread information that the user desires to check, in the information to be provided, by scrolling with the predetermined number of the operators 60.

[Selection of Emphaseized Image: Embodiment 7]

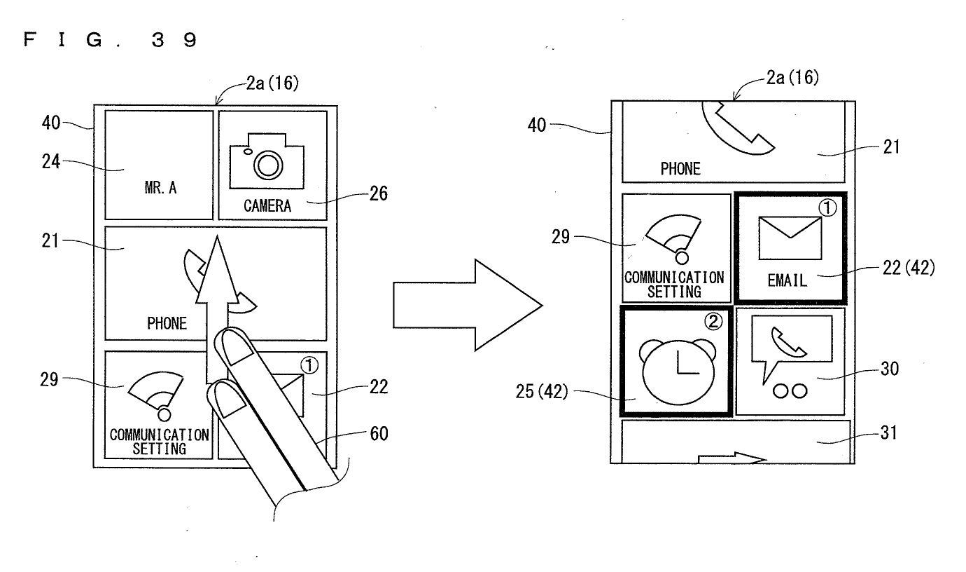

FIG. 40 illustrates a display example of the display 16 according to Embodiment 7. When the predetermined number of the operators 60 have performed the scrolling operation, the image corresponding to the application containing unread information in the information to be provided is selected as the emphaseized image 42 according to Embodiment 6, whereas images of a predetermined size are selected as the emphaseized images 42 according to Embodiment 7.

As illustrated in FIG. 40, for example, when the three of the operators 60 have performed the scrolling operation, the display controller 51 selects, as the emphaseized images 42, the images 22, 31, and 27 that are smaller. FIG. 40 exemplifies the scrolling operations with the three operators 60. Similarly, when, for example, the two of the operators 60 have performed the scrolling operation, the display controller 51 may select smaller images as the emphaseized images 42. Although in FIG. 40, the display controller 51 selects the smaller images as the emphaseized images 42, it may select images of another predetermined size as the emphaseized images 42. Specifically, the display controller 51 selects an image of a predetermined size as the emphaseized image 42 when a predetermined number of the operators 60 have performed the scrolling operation according to Embodiment 7. The associations between the number of the operators 60 and the sizes of the images may be arbitrarily defined by the user.

Embodiments 6 and 7 may be combined. Specifically, for example, when two of the operators 60 have performed the scrolling operation, the emphaseized images 42 may be selected according to Embodiment 6, whereas when three of the operators 60 have performed the scrolling operation, the emphaseized images 42 may be selected according to Embodiment 7.

The images selected as the emphaseized images 42 are changed according to the number of the operators 60 herein. Thus, the user can change the images to be prominently displayed by changing the number of the operators 60 that perform the scrolling operation.

[Selection of Emphaseized Image: Embodiment 8]

FIG. 41 illustrates a display example of the display 16 according to Embodiment 8. According to Embodiment 8, images predetermined by the user are selected as the emphaseized images 42.

As illustrated in FIG. 41, when the operators 60 of a predetermined number have performed the scrolling operation, for example, the images 21, 22, and 26 predetermined by the user are selected as the emphaseized images 42.

Since the images predetermined by the user are selected as the emphaseized images 42 according to Embodiment 8, the user enables the electronic apparatus 1 to select, as the emphaseized images 42, images that are irrelevant to one another, such as the image 21 corresponding to the phone application, the image 22 corresponding to the email application, and the image 26 corresponding to the camera application as illustrated in FIG. 41. Thus, the user can select images as the emphaseized images 42 according to his/her preference.

Furthermore, when the predetermined number of the operators 60 have performed the scrolling operation, an image corresponding to an application that has been started between a time that is before a predetermined time from a current time, and the current time may be selected as the emphaseized image 42. In other words, the electronic apparatus 1 may select, as the emphaseized image 42, an image corresponding to an application that has been lately used by the user. Specifically, for example, when the predetermined number of the operators 60 have performed the scrolling operation, the electronic apparatus 1 selects, as the emphaseized images 42, applications that have been started for 24 hours (within one day) before the current time. Here, the user can easily recognize the image corresponding to the application that has been lately used by the user. The predetermined time is not limited to 24 hours. The user may arbitrarily set the predetermined time.

[Selection of Emphaseized Image: Embodiment 9]

Embodiment 9 will describe an operation of the electronic apparatus 1 when the display target image 41 does not include any image associated with the number of the operators 60 detected by the operation detector 50. Here, the display controller 51 displays the message 43 indicating that there is no image selected as the emphaseized image 42 as according to Embodiment 4. Furthermore, besides displaying the message 43, the display controller 51 may prohibit or disable the display screen 40 from being scrolled.

[Selection of Emphaseized Image: Embodiment 10]

Selecting the emphaseized image 42 based on an image from which the scrolling operation has started according to Embodiments 1 to 3 and 5, and selecting as the emphaseized image 42 an image associated with the number of the operators 60 that perform the scrolling operation according to Embodiments 6 to 8 may be combined and used.

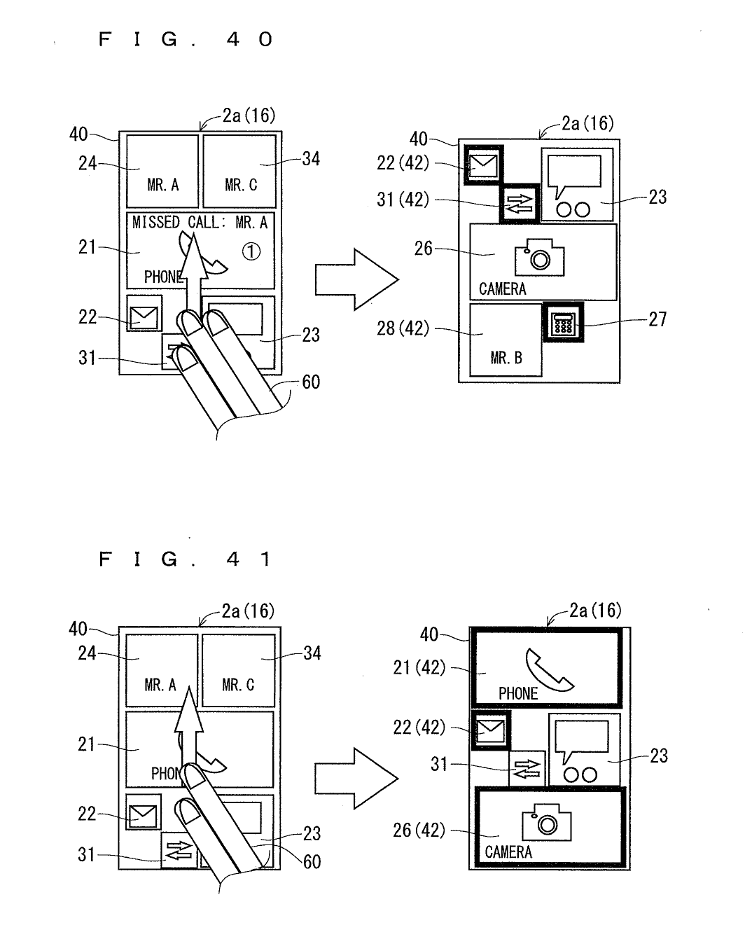

FIG. 42 illustrates a display example of the display 16 according to Embodiment 10. Here, when the scrolling operation has started from the image corresponding to an application that provides a specific name and information associated with the specific name, the image from which the scrolling operation has started, and the image corresponding to the application containing unread information including the specific name in the information to be provided are selected as the emphaseized images 42 as according to Embodiment 2. Furthermore, when two of the operators 60 have performed the scrolling operation, the display controller 51 selects the largest images as the emphaseized image 42 as according to Embodiment 7.

FIG. 42 illustrates that the two of the operators 60 have started the scrolling operations from the image 24 corresponding to the application that provides the name of Mr. A and information associated with the name of Mr. A. The image 22 is the image corresponding to the email application. The receiving function in the email application enables the user to obtain information on an incoming email from Mr. A. Here, the images 24 and 22 are selected as the emphaseized images 42 when the operator 60 has started the scrolling operation from the image 24, and the images 25 and 21 are selected as the emphaseized images 42 when two of the operators 60 have performed the scrolling operation. As a result, the images 24, 22, 25, and 21 are selected as the emphaseized images 42.

[[Displaying Emphaseized Image in Emphasis Display Mode]]

Hereinafter, a display state of the emphaseized image 42 when the electronic apparatus 1 is shifted to the emphasis display mode 54 will be described.

[Displaying Emphaseized Image in Emphasis Display Mode: Embodiment 1]

According to Embodiment 1, the emphaseized image 42 is prominently displayed by changing the color of images arranged in the display target image 41. For example, hue, lightness, or saturation of the image determined as the emphaseized image 42 is changed.

In changing the hue of the images, the difference in hue between the emphaseized image 42 and the images other than the emphaseized image 42 is increased. Accordingly, the emphaseized image 42 and the other images can be distinguished from one another. Furthermore, in changing the lightness or the saturation of the images, the lightness or the saturation of the emphaseized image 42 is increased, which will make the colors of the emphaseized image 42 more prominent. Thus, the user can intuitively recognize the image as prominent. Conversely, the lightness or the saturation of the images other than the emphaseized image 42 that are arranged in the display target image 41 may be reduced. Reducing the lightness or the saturation of the images will make the colors of the images darker or duller. Thus, the user can intuitively recognize that the images should not be selected. At least two of the hue, the lightness, and the saturation of the images may be changed.

[Displaying Emphaseized Image in Emphasis Display Mode: Embodiment 2]

According to Embodiment 2, the emphaseized images 42 are prominently displayed by changing the sizes of the images arranged in the display target image 41. The changing herein refers to not changing the sizes among the three sizes of the images, but using an image of a size larger or smaller than the current size.

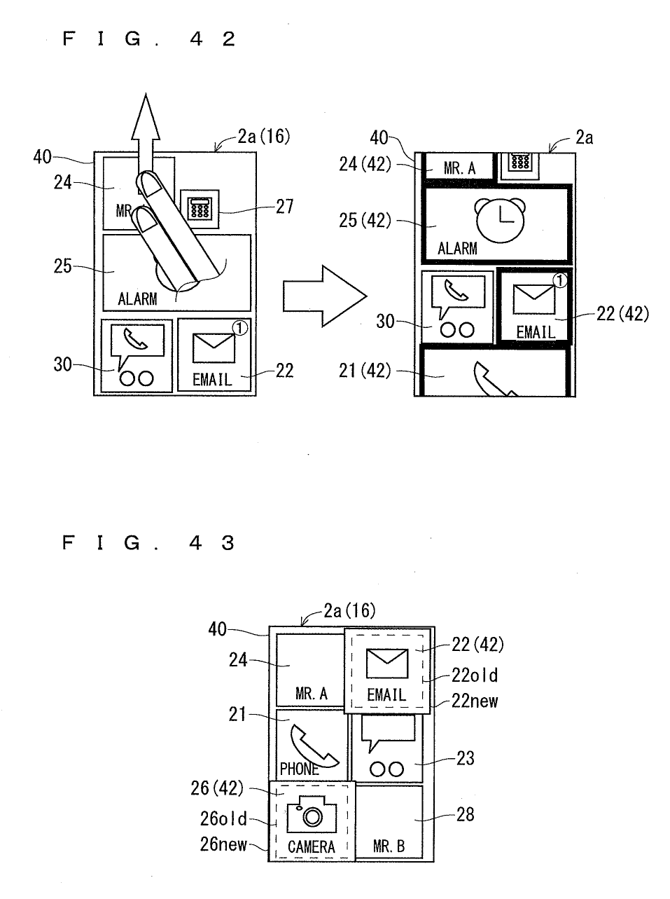

FIG. 43 illustrates a display example of the display screen 40 according to Embodiment 2. As illustrated in FIG. 43, the images 22 and 26 are displayed as the emphaseized images 42. In FIG. 43, new images 22 and 26 prominently displayed as the emphaseized images 42 are displayed larger than old images 22 and 26 before shifting to the emphasis display mode 54 that are indicated by dotted lines. Conversely, the images other than the emphaseized images 42 (the images 24, 21, 23, and 28 in the example of FIG. 43) may be displayed smaller than the emphaseized images 42.

Increasing an area of an image selected as the emphaseized image 42 more than those of the other images arranged in the same size enables the user to intuitively recognize the image displayed larger as the prominent emphaseized image 42.

As seen from the description above, the emphaseized image 42 is prominently displayed by changing the display state of the emphaseized image 42 or changing display states of the images other than the emphaseized image 42 according to Embodiments 1 and 2.

[Displaying Emphaseized Image in Emphasis Display Mode: Embodiment 3]

According to Embodiment 3, the emphaseized image 42 is prominently displayed by attaching an identification image (mark) 44 thereon. FIG. 44 illustrates a display example of the display 16 according to Embodiment 3. In FIG. 44, the images 22, 21, and 28 are displayed as the emphaseized images 42. The identification images 44 are attached to the images 22, 21, and 28. Attaching the identification image 44 on the image selected as the emphaseized image 42 enables the user to easily recognize the image with the identification image 44 as the emphaseized image 42.

[Displaying Emphaseized Image in Emphasis Display Mode: Embodiment 4]

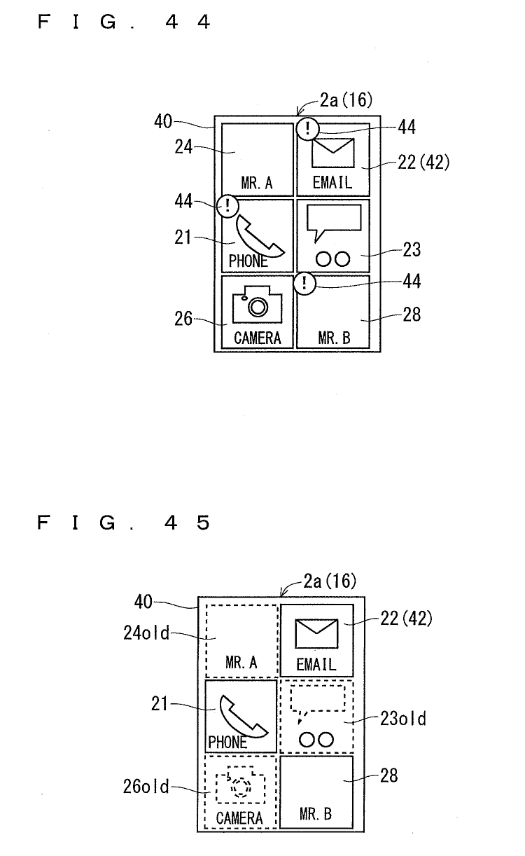

According to Embodiment 4, the emphaseized image 42 is prominently displayed by preventing the images other than the emphaseized image 42 from appearing. FIG. 45 illustrates a display example of the display 16 according to Embodiment 4. FIG. 45 illustrates an example in which the images 22, 21, and 28 are selected as the emphaseized images 42. Furthermore, old images 24, 23, and 26 that are indicated by dotted lines in FIG. 45 are images displayed on the display 16 before shifting to the emphasis display mode 54.

Since the images other than the images 22, 21, and 28 selected as the emphaseized images 42 are not displayed according to Embodiment 4, the user can easily recognize the emphaseized images 42.

[[Range for Scrolling Display Screen]]

The range of the display target image 41 that is to be displayed on the display 16 will be described hereinafter. The display screen 40 to be displayed on the display 16 is scrolled within a range 45 including the emphaseized images 42, in the display target image 41.

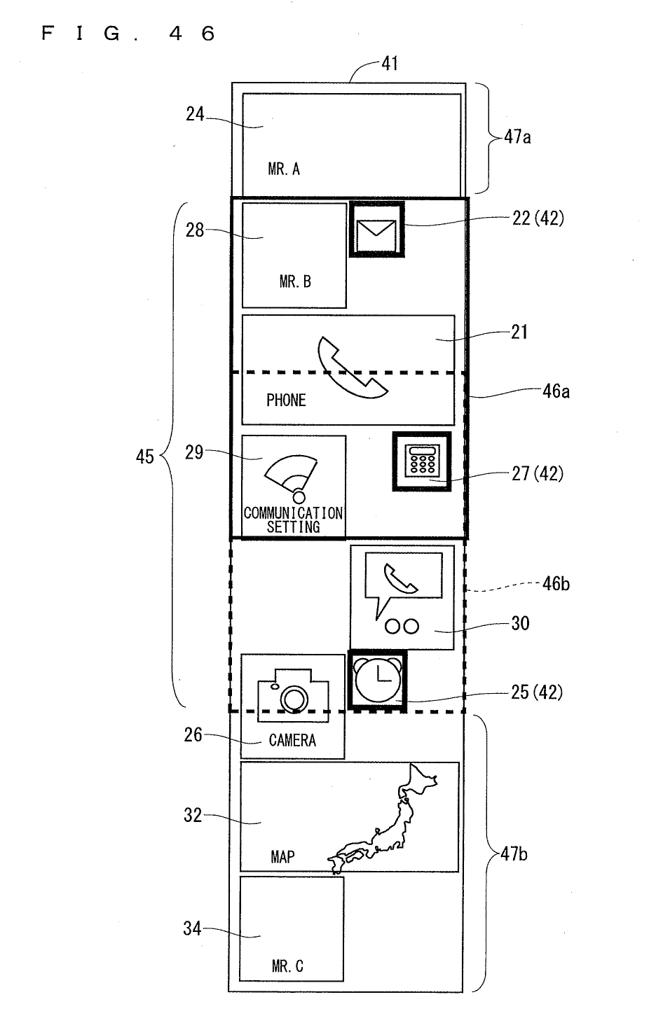

FIG. 46 exemplifies the display target image 41 in the emphasis display mode 54. As illustrated in FIG. 46, for example, when the images 22, 27, and 25 are selected as the emphaseized images 42, the display screen 40 is scrolled within the range 45 including the images 22, 27, and 25. Specifically, even when the display screen 40 is scrolled, an upper region 47a over the range 45 and a lower region 47b under the range 45 are neither included in the display screen 40 nor displayed on the display 16.

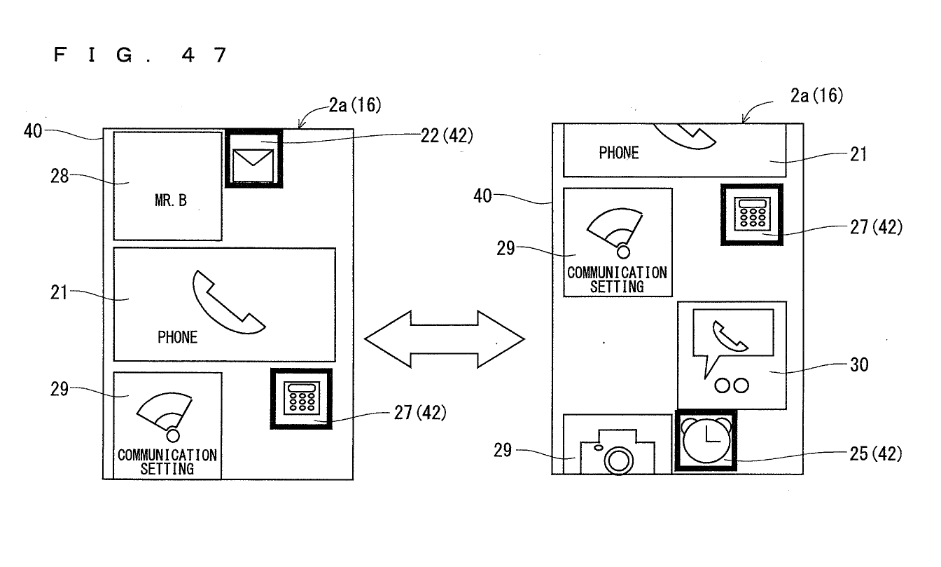

FIG. 47 exemplifies the display screen 40 corresponding to the display target image 41 in FIG. 46. FIG. 47 to the left illustrates a display example of the display 16 when a downward scrolling operation has been performed until the display screen 40 comes to a state in which the display screen 40 is not scrolled any more. The display screen 40 illustrated in FIG. 47 to the left is a partial image 46a included in the display target image 41 in FIG. 46. In contrast, FIG. 47 to the right illustrates a display example of the display 16 when a upward scrolling operation has been performed until the display screen 40 comes to the state in which the display screen 40 is not scrolled any more The display screen 40 illustrated in FIG. 47 to the right is a partial image 46b included in the display target image 41 in FIG. 46.

Scrolling the display screen 40 within the range 45 including the emphaseized images 42 enables the user to narrow down a range within which the target image is searched for and to easily find out the target image, in the display target image 41.

[[Mode During Scrolling Display Screen]]

When the operation detector 50 detects tapping on an image other than the emphaseized image 42 in the emphasis display mode 54, the controller 10 of the electronic apparatus 1 does not have to start the application corresponding to the tapped image. In other words, even when the user mistakenly selects an image that is not related to the target image, the application corresponding to the image that is not related to the target image does not have to be started. This can reduce the probability of redoing the operation due to the mistake in the previous operation by the user.

[[State of Display Image]]

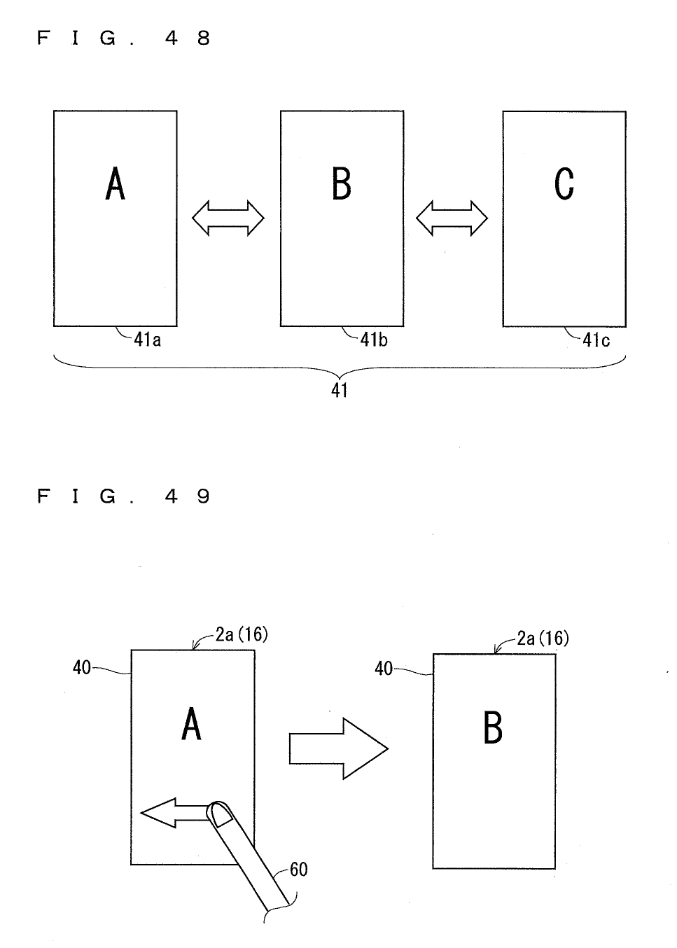

Although the above Embodiment describes a state in which a part of the display target image 41 is displayed as the display screen 40 on the display 16, the display target image 41 does not always have to be one image. For example, the display target image 41 may include images (display target images 41a, 41b, and 41c) as illustrated in FIG. 48. Here, the scrolling operation on the display 16 enables the display screen 40 to be scrolled within the display target images 41. Specifically, the image displayed on the display 16 is switched among the display target images 41a, 41b, and 41c by the scrolling. For example, as illustrated in FIG. 49, when the operator 60 performs the scrolling operation on the display 16 that displays the display target image 41a, the display 16 can display the display target image 41b subsequent to the display target image 41a.

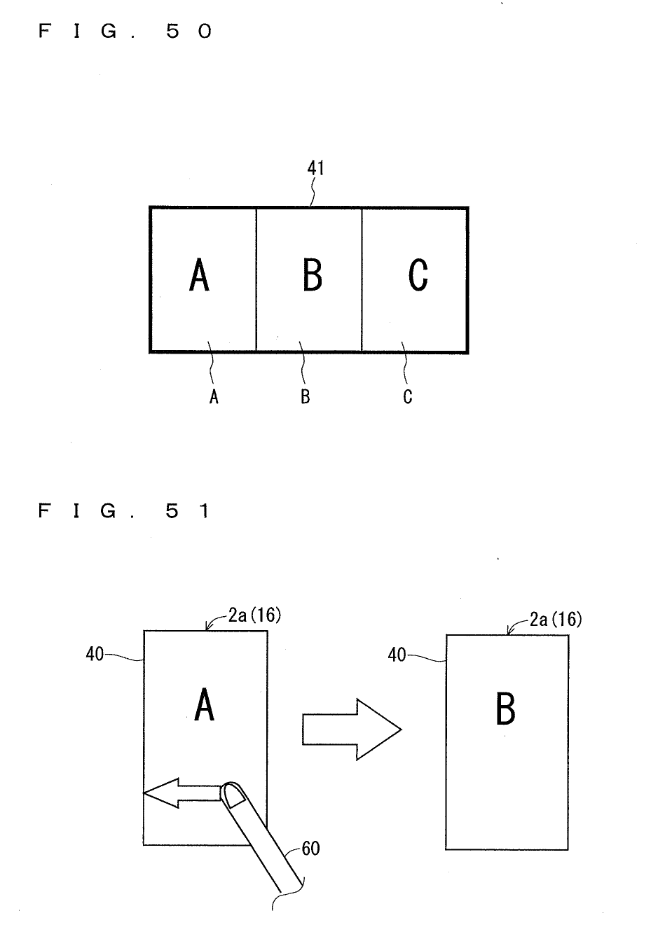

Furthermore, a display region within the display target image 41 may be moved by the scrolling operation, according to the size of the display region. For example, as illustrated in FIG. 50, assume that the display target image 41 is three times as large as the display region (display regions A, B, and C from the left). Here, the scrolling operation changes the display region by one display region in a direction opposite to the scrolling operation with respect to the partial image currently displayed on the display 16. Specifically, for example, as illustrated in FIG. 51, when the display region A is displayed on the display 16 and the operator 60 performs the scrolling operation to the left, the display area is moved by one display area to the right, thus, displaying the display region B.

[Other Modifications]

The examples above describe the application of the present disclosure to mobile phones. The present disclosure is applicable to any electronic apparatuses including at least a touch panel and a display. The present disclosure is applicable to, for example, personal computers (PCs), personal digital assistants (PDAs), and television (TV) receivers.

While the electronic apparatus 1 is described in detail above, the foregoing description is in all aspects illustrative and not restrictive. Various modifications described above may be combined with one another unless any contradiction occurs. It is understood that numerous modifications that have not yet been described can be devised without departing from the scope of the present disclosure.

1. An electronic apparatus, comprising:
a storage that stores an application program;
a display;
a display controller that causes the display to display an application-relevant image corresponding to the application program; and
an operation detector that detects an operation of an operator on the display,
wherein the display controller has an operation mode for enabling the display to display a plurality of application-relevant images by scrolling a display screen displayed by the display, the display screen including the application-relevant image,
the display controller in the operation mode causes the display screen to be scrolled when the operation detector detects a scrolling operation of the display screen,
the display controller in the operation mode has a display mode in which the display screen is displayed on the display so that a specific application-relevant image is more prominent among the application-relevant images, and
the display controller in the display mode determines whether or not to maintain the display mode, based on the scrolling operation detected by the operation detector.

2. The electronic apparatus according to claim 1,
wherein when the scrolling operation starts from a first application-relevant image included in the application-relevant images, the display controller determines a second application-relevant image related to the first application-relevant image as the specific application-relevant image.

3. The electronic apparatus according to claim 2,
wherein the application-relevant images include the second application-relevant image corresponding to a second application program belonging to a category to which a first application program corresponding to the first application-relevant image belongs.

4. The electronic apparatus according to claim 2,
wherein the application-relevant images include the second application-relevant image corresponding to a second application program that provides third information including unread second information including first information provided by a first application program corresponding to the first application-relevant image.

5. The electronic apparatus according to claim 4,
wherein the first information comprises a name, and
the second information comprises one of missed call information including the name, incoming email information including the name, and received message information including the name.

6. The electronic apparatus according to claim 2,
wherein the application-relevant images include the second application-relevant image identical in size to the first application-relevant image.

7. The electronic apparatus according to claim 2,
wherein the display controller causes the display to display a message indicating absence of the second application-relevant image when the application-relevant images do not include the second application-relevant image.

8. The electronic apparatus according to claim 7,
wherein the display controller causes the display to display the message indicating absence of the second application-relevant image and disables the display screen from being scrolled, when the application-relevant images do not include the second application-relevant image.

9. The electronic apparatus according to claim 1,
wherein the display controller determines, as the specific application-relevant image, a first application-relevant image corresponding to the number of operators that perform the scrolling operation.

10. The electronic apparatus according to claim 9,
wherein the display controller changes the first application-relevant image according to the number of the operators that perform the scrolling operation.

11. The electronic apparatus according to claim 9,
wherein the application-relevant images include the first application-relevant image corresponding to the application program that provides information including unread information.

12. The electronic apparatus according to claim 9,
wherein the application-relevant images include the first application-relevant image corresponding to the application program that has been started between a first time and a current time, the first time being before a predetermined time from the current time.

13. The electronic apparatus according to claim 9,
wherein the display controller causes the display to display a message indicating absence of the first application-relevant image when the application-relevant images do not include the first application-relevant image.

14. The electronic apparatus according to claim 13,
wherein the display controller causes the display to display the message indicating absence of the first application-relevant image and disables the display screen from being scrolled, when the application-relevant images do not include the first application-relevant image.

15. The electronic apparatus according to claim 1,
wherein the electronic apparatus doe's not start the application program when the display controller is in the display mode and the operation detector detects an operation of selecting a first application-relevant image other than the specific application-relevant image among the application-relevant images, the application program corresponding to the first application-relevant image.

16. The electronic apparatus according to claim 1,
wherein the display controller causes the display screen to be scrolled by changing, in a single display target image, a partial image to be displayed on the display, and
the display controller changes the partial image to be displayed on the display, within a range including the specific application-relevant image in the single display target image.

17. The electronic apparatus according to claim 1,
wherein the display controller in the display mode causes the display to prominently display the specific application-relevant image in the display screen by changing a display state of the specific application-relevant image or changing a display state of the application-relevant image other than the specific application-relevant image.

18. The electronic apparatus according to claim 1,
wherein the display controller in the display mode causes the display to prominently display the specific application-relevant image on the display screen by excluding, from the display screen, the application-relevant image other than the specific application-relevant image.

19. A non-transitory computer-readable recording medium in which a program for controlling an electronic apparatus is stored, the electronic apparatus including a display and a storage that stores an application program, the program causing the electronic apparatus to execute:
(a) operating the electronic apparatus in an operation mode for enabling the display to display a plurality of application-relevant images by scrolling a display screen including an application-relevant image corresponding to the application program, the display screen being displayed by the display;
(b) operating the electronic apparatus in a display mode in which the display screen is displayed on the display so that a specific application-relevant image is more prominent among the application-relevant images, when the electronic apparatus is in the operation mode;
(c) detecting a scrolling operation of the display screen on the display by an operator;
(d) scrolling the display screen, when the electronic apparatus is in the operation mode and the scrolling operation is detected in the step (c);
(e) shifting to the display mode, when the electronic apparatus is in the operation mode and the scrolling operation is detected in the step (c); and
(f) determining whether or not to maintain the display mode based on the scrolling operation detected in the step (c), when the electronic apparatus is in the display mode.

20. An operating method of an electronic apparatus including a display and a storage that stores an application program, the operating method comprising:
(a) operating in an operation mode for enabling the display to display a plurality of application-relevant images by scrolling a display screen including an application-relevant image corresponding to the application program, the display screen being displayed by the display;
(b) operating in a display mode in which the display screen is displayed on the display so that a specific application-relevant image is more prominent among the application-relevant images, when the electronic apparatus is in the operation mode;
(c) detecting a scrolling operation of the display screen on the display by an operator;
(d) scrolling the display screen, when the electronic apparatus is in the operation mode and the scrolling operation is detected in the step (c);
(e) determining whether or not to maintain the display mode based on the scrolling operation detected in the step (c), when the electronic apparatus is in the display mode; and
(f) shifting to the display mode, when the electronic apparatus detects start of an operation while detecting no operation on the display.
